(19) United States
(12) Patent Application Publication
(10) Pub. No.: US 2017/0111923 A1
(43) Pub. Date: Apr. 20, 2017

(54) USER EQUIPMENTS, BASE STATIONS AND METHODS FOR LOW LATENCY RADIO COMMUNICATIONS

(71) Applicant: Sharp Laboratories of America, Inc., Camas, WA (US)

(72) Inventors: Toshizo Nogami, Vancouver, WA (US); Zhanping Yin, Vancouver, WA (US)

(21) Appl. No.: 15/292,007

(22) Filed: Oct. 12, 2016

Related U.S. Application Data
(60) Provisional application No. 62/241,525, filed on Oct. 14, 2015.

(51) Int. Cl. H04W 72/12; H04L 1/00

(52) U.S. Cl. CPC H04W 72/1263; H04L 1/0018; H04W 88/02

(57) ABSTRACT

A user equipment (UE) is described. The UE includes a higher-layer processor configured to configure a secondary cell group (SCG) and to configure a shortened transmission timing interval (TTI) for the SCG. The UE also includes a physical channel receiver configured to use a normal TTI for a master cell group (MCG) and to use the shortened TTI for the SCG.

### RELATED APPLICATIONS

This application is related to and claims priority from U.S. Provisional Patent Application No. 62/241,525, entitled “USER EQUIPMENTS, BASE STATIONS AND METHODS FOR LOW LATENCY RADIO COMMUNICATIONS,” filed on Oct. 14, 2015, which is hereby incorporated by reference herein, in its entirety.

### TECHNICAL FIELD

The present disclosure relates generally to communication systems. More specifically, the present disclosure relates to user equipments (UEs), base stations and methods for low latency radio communications.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more evolved NodeBs (eNBs) and one or more user equipments (UEs) in which systems and methods for low latency radio communications may be implemented;

FIG. 2 is block diagram illustrating a detailed configuration of an eNB and a UE in which systems and methods for low latency radio communications may be implemented;

FIG. 3 is a flow diagram illustrating a method for low latency radio communications by a UE;

FIG. 4 is a flow diagram illustrating a method for low latency radio communications by an eNB;

FIG. 5 is a diagram illustrating one example of a radio frame that may be used in accordance with the systems and methods disclosed herein;

FIG. 6 is a diagram illustrating one example of a resource grid;

FIG. 7 illustrates an example of a physical channel structure for a normal transmission time interval (TTI);

FIG. 8 illustrates an example of a retransmission cycle of a downlink (DL) transport block (DL-TB);

FIG. 9 illustrates an example of a retransmission cycle of an uplink (UL) transport block (UL-TB);

FIG. 10 illustrates an example of a physical channel structure for a shortened TTI;

FIG. 11 illustrates an example of a retransmission cycle of a DL-TB in the case of a shortened TTI;

FIG. 12 illustrates an example of a retransmission cycle of a UL-TB in the case of a shortened TTI;

FIG. 13 illustrates another example of a retransmission cycle of a UL-TB in the case of a shortened TTI;

FIG. 14 illustrates examples of resource element (RE) mapping of shortened physical downlink control channel (SPDCCH) and shortened physical downlink shared channel (SPDSCH);

FIG. 15 illustrates an example of a time domain signal of SPDCCH;

FIG. 16 illustrates examples of RE mapping of shortened physical uplink control channel (SPUCCH) and shortened physical uplink shared channel (SPUSCH);

FIG. 17 illustrates an example of a retransmission cycle of a DL-TB with a shortened round trip time (RTT);

FIG. 18 illustrates an example of a retransmission cycle of a UL-TB with the shortened RTT;

FIG. 19 illustrates various components that may be utilized in a UE;

FIG. 20 illustrates various components that may be utilized in an eNB;

FIG. 21 is a block diagram illustrating one implementation of a UE in which systems and methods for low latency radio communications may be implemented; and

FIG. 22 is a block diagram illustrating one implementation of an eNB in which systems and methods for low latency radio communications may be implemented.

### DETAILED DESCRIPTION

A user equipment (UE) is described. The UE includes a higher-layer processor configured to configure a secondary cell group (SCG) and to configure a shortened transmission timing interval (TTI) for the SCG. The UE also includes a physical channel receiver configured to use a normal TTI for a master cell group (MCG) and to use the shortened TTI for the SCG.

The shortened TTI may include two Orthogonal Frequency Division Multiplexing (OFDM) symbols. A first OFDM symbol of the two OFDM symbols may contain a physical control channel. A second OFDM symbol of the two OFDM symbols may contain a physical shared channel. The physical control channel may be mapped on discrete subcarriers of which frequency intervals are uniform.

An evolved node B (eNB) is also described. The eNB includes a higher-layer processor configured to configure, in a user equipment (UE), a secondary cell group (SCG) and to configure a shortened transmission timing interval (TTI) for the SCG. The eNB also includes a physical channel transmitter configured to use a normal TTI for a master cell group (MCG) and to use the shortened TTI for the SCG.

A method in a user equipment (UE) is also described. The method includes configuring a secondary cell group (SCG). The method also includes configuring a shortened transmission timing interval (TTI) for the SCG. The method further includes using a normal TTI for a master cell group (MCG). The method additionally includes using the shortened TTI for the SCG.

A method in an evolved node B (eNB) is also described. The method includes configuring, in a user equipment (UE), a secondary cell group (SCG). The method also includes configuring a shortened transmission timing interval (TTI) for the SCG. The method further includes using a normal TTI for a master cell group (MCG). The method additionally includes using the shortened TTI for the SCG.

A method for a user equipment (UE) is also described. The method includes configuring a secondary cell group (SCG). The method also includes configuring a shortened transmission timing interval (TTI) for the SCG. The method further includes using a normal TTI for a master cell group (MCG). The method additionally includes using the shortened TTI for the SCG.

A method for an evolved node B (eNB) is also described. The method includes configuring, in a user equipment (UE), a secondary cell group (SCG). The method also includes configuring, in the user equipment (UE), a shortened transmission timing interval (TTI) for the SCG. The method further includes using a normal TTI for a master cell group (MCG). The method additionally includes using the shortened TTI for the SCG.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed may involve carrier aggregation. Carrier aggregation refers to the concurrent utilization of more than one carrier. In carrier aggregation, more than one cell may be aggregated to a UE. In one example, carrier aggregation may be used to increase the effective bandwidth available to a UE. The same TDD uplink-downlink (UL/DL) configuration has to be used for TDD CA in Release-10, and for intra-band CA in Release-11. In Release-11, inter-band TDD CA with different TDD UL/DL configurations is supported. The inter-band TDD CA with different TDD UL/DL configurations may provide the flexibility of a TDD network in CA deployment. Furthermore, enhanced interference management with traffic adaptation (eIMTA) (also referred to as dynamic UL/DL reconfiguration) may allow flexible TDD UL/DL reconfiguration based on the network traffic load.

It should be noted that the term “concurrent” and variations thereof as used herein may denote that two or more events may overlap each other in time and/or may occur near in time to each other. Additionally, “concurrent” and variations thereof may or may not mean that two or more events occur at precisely the same time.

Packet data latency is a performance metric of a communication system. There is a requirement to reduce the latency from the view point of the perceived responsiveness of the system for new features (e.g., real-time communication for robotics applications) as well as more efficient transactions of the current HTTP/TCP-based packets. In addition, the Tactile Internet, which will have significant impacts on future business, market and human lives, needs extremely reduced latency signals. The Tactile Internet could be provided through the same band as current cellular communication, a different band (e.g., a higher frequency band such as a millimeter wave), or both.

A promising candidate for realizing the latency reduction is a shortened transmission time interval (TTI) and/or a shortened round trip time (RTT). However, the exact physical channel designs for the shortened TTI and/or shortened RTT have not been defined.

The described systems and methods provide physical channel structures for the shortened TTI and/or RTT. The structure may include: a 2-OFDM-symbol-long TTI that consists of one OFDM symbol for a shortened PDCCH (SPDCCH) and one OFDM symbol for a shortened PDSCH (SPDSCH); a 2-OFDM-symbol-long TTI that consists of one OFDM symbol for a shortened PUCCH (SPUCCH) and one OFDM symbol for a shortened PUSCH (SPUSCH); and discrete subcarriers in the frequency domain may be used for a SPDCCH transmission.

The network (e.g., eNB) may configure whether the normal TTI/RTT or the shortened TTI/RTT are used with respect to each serving cell group. The UE may assume use of shortened TTI/RTT in the serving cell of the cell group for which the shortened TTI/RTT is configured.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

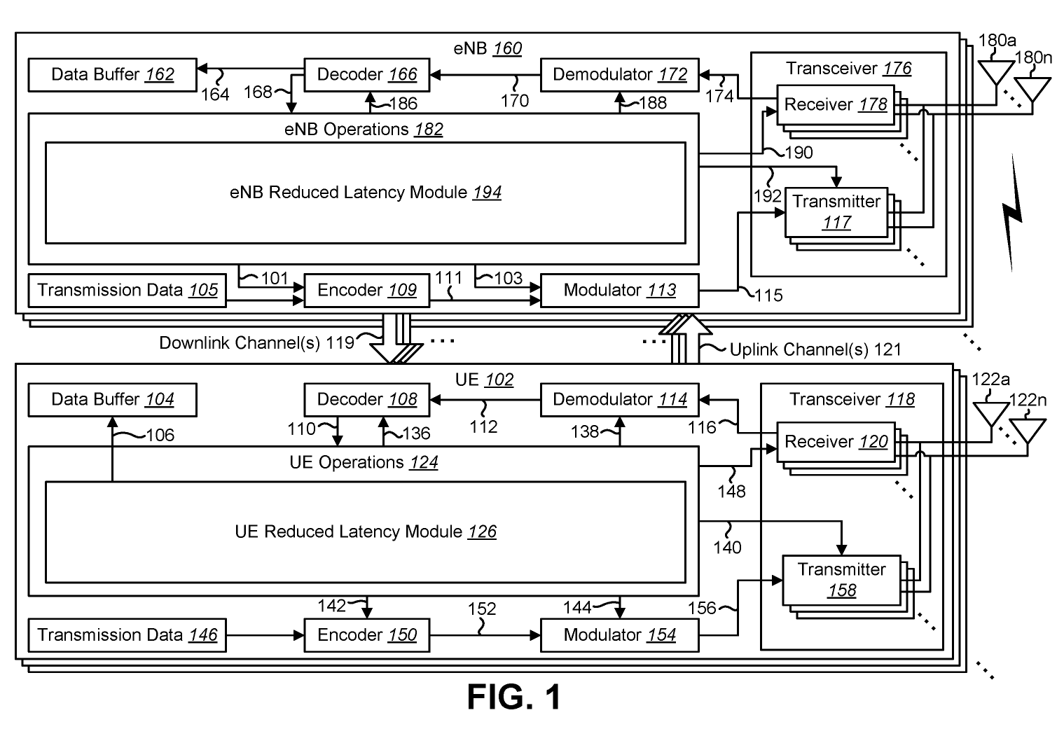

FIG. 1 is a block diagram illustrating one implementation of one or more eNBs 160 and one or more UEs 102 in which systems and methods for low latency radio communications may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UE reduced latency module 126.

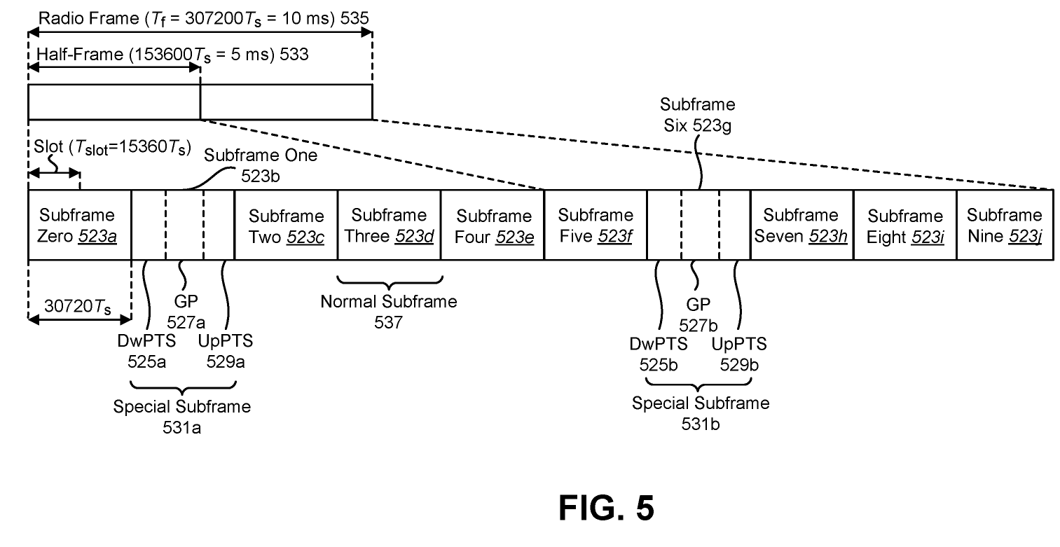

Downlink and uplink transmissions may be organized into radio frames with a 10 millisecond (ms) duration. For a frame structure Type 1 (e.g., FDD), each 10 ms radio frame is divided into ten equally sized sub-frames. Each sub-frame consists of two equally sized slots. For a frame structure Type 2 (e.g., TDD), each 10 ms radio frame consists of two half-frames of 5 ms each. Each half-frame consists of eight slots of length 0.5 ms and three special fields: DwPTS, GP and UpPTS. The length of DwPTS and UpPTS is configurable subject to the total length of DwPTS, GP and UpPTS being equal to 1 ms. Additional details about frame structure are discussed in connection with FIG. 5.

Both 5 ms and 10 ms switch-point periodicity are supported. Subframe 1 in all configurations and subframe 6 in a configuration with 5 ms switch-point periodicity consist of DwPTS, GP and UpPTS. Subframe 6 in a configuration with 10 ms switch-point periodicity consists of DwPTS only. All other subframes consist of two equally sized slots.

In LTE license access, subframes are classified into 2 types of subframes. One is the normal subframe that contains only either one of DL transmission and UL transmission. LTE license access with FDD has only the normal subframe. The other is the special subframe that contains three fields DwPTS, GP and UpPTS. DwPTS and UpPTS are durations reserved for DL transmission and UL transmission, respectively.

LTE license access with TDD can have the special subframe as well as the normal subframe. The lengths of DwPTS, GP and UpPTS can be configured by using a special subframe configuration. Any one of the following ten configurations may be set as a special subframe configuration.

1) Special subframe configuration 0: DwPTS consists of 3 OFDM symbols. UpPTS consists of 1 single carrier frequency-division multiple access (SC-FDMA) symbol.

2) Special subframe configuration 1: DwPTS consists of 9 OFDM symbols for normal CP and 8 OFDM symbols for extended CP. UpPTS consists of 1 SC-FDMA symbol.

3) Special subframe configuration 2: DwPTS consists of 10 OFDM symbols for normal CP and 9 OFDM symbols for extended CP. UpPTS consists of 1 SC-FDMA symbol.

4) Special subframe configuration 3: DwPTS consists of 11 OFDM symbols for normal CP and 10 OFDM symbols for extended CP. UpPTS consists of 1 SC-FDMA symbol.

5) Special subframe configuration 4: DwPTS consists of 12 OFDM symbols for normal CP and 3 OFDM symbols for extended CP. UpPTS consists of 1 SC-FDMA symbol for normal CP and 2 SC-FDMA symbol for extended CP.

6) Special subframe configuration 5: DwPTS consists of 3 OFDM symbols for normal CP and 8 OFDM symbols for extended CP. UpPTS consists of 2 SC-FDMA symbols.

7) Special subframe configuration 6: DwPTS consists of 9 OFDM symbols. UpPTS consists of 2 SC-FDMA symbols.

8) Special subframe configuration 7: DwPTS consists of 10 OFDM symbols for normal CP and 5 OFDM symbols for extended CP. UpPTS consists of 2 SC-FDMA symbols.

9) Special subframe configuration 8: DwPTS consists of 11 OFDM symbols. UpPTS consists of 2 SC-FDMA symbols. Special subframe configuration 8 can be configured only for normal CP

10) Special subframe configuration 9: DwPTS consists of 6 OFDM symbols. UpPTS consists of 2 SC-FDMA symbols. Special subframe configuration 9 can be configured only for normal CP.

In the downlink, the OFDM access scheme may be employed. In the downlink, PDCCH, EPDCCH, PDSCH and the like may be transmitted. A downlink radio frame may consist of multiple pairs of downlink resource blocks (RBs). The downlink RB pair is a unit for assigning downlink radio resources, defined by a predetermined bandwidth (RB bandwidth) and a time slot. Two slots (i.e., slot0 and slot1) equal one subframe. The downlink RB pair consists of two downlink RBs that are continuous in the time domain.

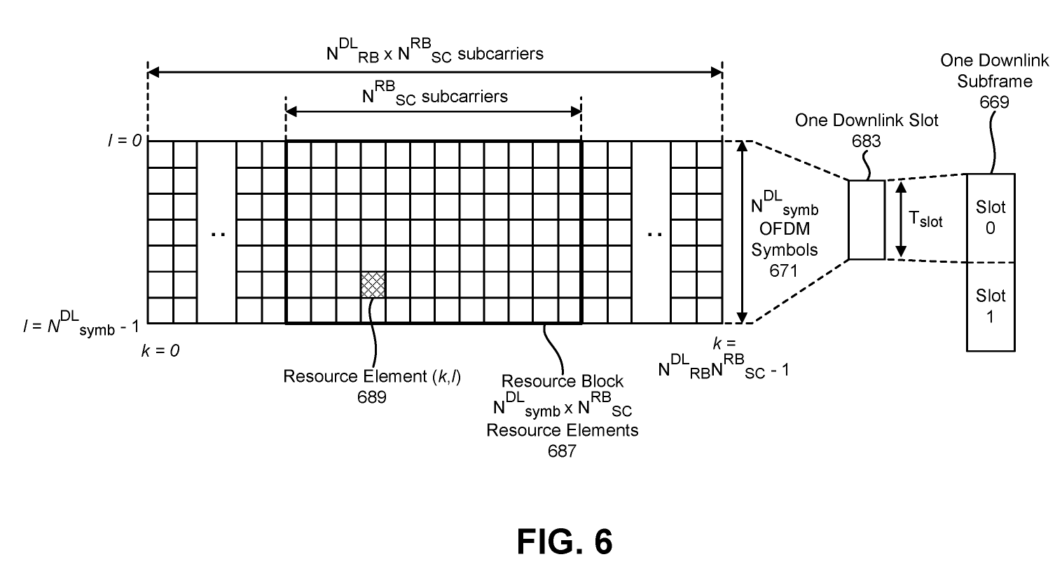

The downlink RB consists of twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k, l) in a slot, where k and l are indices in the frequency and time domains, respectively. While downlink subframes in one component carrier (CC) are discussed herein, downlink subframes are defined for each CC and downlink subframes are substantially in synchronization with each other among CCs. An example of a resource grid is discussed in connection with FIG. 6.

In Carrier Aggregation (CA), two or more CCs may be aggregated to support wider transmission bandwidths (e.g., up to 100 MHz, beyond 100 MHz). A UE 102 may simultaneously receive or transmit on one or multiple CCs. Serving cells can be classified into a primary cell (PCell) and a secondary cell (SCell).

The Primary Cell may be the cell, operating on the primary frequency, in which the UE 102 either performs the initial connection establishment procedure or initiates the connection re-establishment procedure, or the cell indicated as the primary cell in the handover procedure. The Secondary Cell may be a cell, operating on a secondary frequency, which may be configured once an RRC connection is established and which may be used to provide additional radio resources.

In the downlink, the carrier corresponding to the PCell is the downlink primary component carrier (DL PCC) while in the uplink it is the uplink primary component carrier (UL PCC). Similarly, in the downlink, the carrier corresponding to the SCell is the downlink secondary component carrier (DL SCC) while in the uplink it is the uplink secondary component carrier (UL SCC). The UE 102 may apply a system information acquisition (i.e., acquisition of broadcast system information) and change monitoring procedures for the PCell. For an SCell, E-UTRAN may provide, via dedicated signaling, all system information relevant for operation in an RRC_CONNECTED message when adding the SCell.

In Dual Connectivity (DC), each of two or more serving cells may belong to either one of a master cell group (MCG) or a secondary cell group (SCG). The MCG is associated with a master eNB (MeNB) while the SCG is associated with a secondary eNB (SeNB).

DC operation may be configured to utilize radio resources provided by two distinct schedulers, located in the MeNB and SeNB. In the case of DC, the UE 102 may be configured with two Medium Access Control (MAC) entities: one MAC entity for MeNB and one MAC entity for SeNB.

When a UE 102 is configured with CA in the MCG, CA principles may generally apply to the MCG. For the SCG, at least one cell in the SCG has a configured UL CC and one of them, named the PSCell, is configured with PUCCH resources. Unlike the CA for which a UE 102 should cope with a delay spread of up to 30.26 μs among the component carriers, two operations are defined for the DC: synchronous and asynchronous DC. In synchronous DC operation, the UE 102 can cope with a maximum reception timing difference up to at least 33 μs between CGs. In asynchronous DC operation, the UE 102 can cope with a maximum reception timing difference up to 500 μs between CGs.

Even in the case that DC is not configured, one or more PUCCH cell group(s) can be configured. A PUCCH cell group having a PCell may be referred to as a MCG or master PUCCH cell group (MPCG). The other cell group(s) may be referred to as a SCG or secondary PUCCH cell group (SPCG). Each SCG (or SPCG) may include a PSCell, on which a PUCCH transmission(s) for the SCG (or SPCG) can be performed.

A downlink physical channel may correspond to a set of resource elements carrying information originating from higher layers. The following downlink physical channels may be defined. A physical downlink shared channel (PDSCH) may carry a transport block provided by a higher layer. The transport block may contain user data, higher layer control messages, physical layer system information. The scheduling assignment of PDSCH in a given subframe may normally be carried by PDCCH or EPDCCH in the same subframe.

A physical broadcast channel (PBCH) may carry a master information block, which is required for an initial access.

A physical multicast channel (PMCH) may carry MBMS related data and control information.

A physical control format indicator channel (PCFICH) may carry a control format indicator (CFI) specifying the number of OFDM symbols on which PDCCHs are mapped.

A physical downlink control channel (PDCCH) may carry a scheduling assignment (also referred to as a DL grant) or an UL grant. The PDCCH may be transmitted via the same antenna port (e.g., CRS port) as the PBCH.

A physical hybrid ARQ indicator channel (PHICH) may carry UL-associated HARQ-ACK information.

An enhanced physical downlink control channel (EPDCCH) may carry a scheduling assignment or an UL grant. The EPDCCH may be transmitted via a different antenna port (e.g., DM-RS port) from the PBCH and PDCCH. Possible REs on which EPDCCHs are mapped may be different from those for PDCCH, though they may partially overlap.

A downlink physical signal may correspond to a set of resource elements used by the physical layer but may not carry information originating from higher layers.

A cell-specific reference signal (CRS) may be assumed to be transmitted in all downlink subframes and DwPTS. For a normal subframe with normal CP, a CRS may be mapped on REs that are located in the 1st, 2nd, and 5th OFDM symbols in each slot. A CRS may be used for demodulation of the PDSCH, CSI measurement and RRM measurement.

A CSI-RS may be transmitted in the subframes that are configured by higher layer signaling. The REs on which a CSI-RS is mapped are also configured by higher layer signaling. A CSI-RS may be further classified into non zero power (NZP) CSI-RS and ZP (zero power) CSI-RS. A part of a ZP CSI-RS resources may be configured as a CSI-IM resource, which may be used for interference measurement.

A UE-specific RS (UE-RS) may be assumed to be transmitted in PRB pairs that are allocated for the PDSCH intended to the UE 102. UE-RS may be used for demodulation of the associated PDSCH.

A Demodulation RS (DM-RS) may be assumed to be transmitted in PRB pairs that are allocated for EPDCCH transmission. DM-RS may be used for demodulation of the associated EPDCCH.

Primary/secondary synchronization signals may be transmitted to facilitate the UE's 102 cell search, which is the procedure by which the UE 102 acquires time and frequency synchronization with a cell and detects the physical layer Cell ID of that cell. E-UTRA cell search supports a scalable overall transmission bandwidth corresponding to 6 resource blocks and upwards.

A discovery signal may consist of CRS, primary/secondary synchronization signals NZP-CSI-RS (if configured). The UE 102 may assume a discovery signal occasion once every DMTC-Periodicity. The eNB 160 using cell on/off may adaptively turn the downlink transmission of a cell on and off. A cell whose downlink transmission is turned off may be configured as a deactivated SCell for a UE 102. A cell performing on/off may transmit only periodic discovery signals and UEs 102 may be configured to measure the discovery signals for RRM. A UE 102 may perform RRM measurement and may discover a cell or transmission point of a cell based on discovery signals when the UE 102 is configured with discovery-signal-based measurements.

In Rel-12, there are ten transmission modes. These transmission modes may be configurable for an LAA SCell. These transmission modes are illustrated in Table (1).

TABLE (1)

| Transmission | | |
|---|---|---|
| mode | DCI format | Transmission scheme |
| Mode 1 | DCI format 1A | Single antenna port |
| | DCI format 1 | Single antenna port |
| Mode 2 | DCI format 1A | Transmit diversity |
| | DCI format 1 | Transmit diversity |
| Mode 3 | DCI format 1A | Transmit diversity |
| | DCI format 2A | Large delay CDD or Transmit diversity |
| Mode 4 | DCI format 1A | Transmit diversity |
| | DCI format 2 | Closed-loop spatial multiplexing or |
| | | Transmit diversity |
| Mode 5 | DCI format 1A | Transmit diversity |
| | DCI format 1D | Multi-user MIMO |
| Mode 6 | DCI format 1A | Transmit diversity |
| | DCI format 1B | Closed-loop spatial multiplexing using |
| | | a single transmission layer |
| Mode 7 | DCI format 1A | Single-antenna port (for a single CRS |
| | | port), transmit diversity (otherwise) |
| | DCI format 1 | Single-antenna port |
| Mode 8 | DCI format 1A | Single-antenna port (for a single CRS |
| | | port), transmit diversity (otherwise) |
| | DCI format 2B | Dual layer transmission or single-antenna |
| | | port |
| Mode 9 | DCI format 1A | Single-antenna port (for a single CRS |
| | | port or MBSFN subframe), transmit |
| | | diversity (otherwise) |
| | DCI format 2C | Up to 8 layer transmission or |
| | | single-antenna port |
| Mode 10 | DCI format 1A | Single-antenna port (for a single CRS |
| | | port or MBSFN subframe), transmit |
| | | diversity (otherwise) |
| | DCI format 2D | Up to 8 layer transmission or |
| | | single-antenna port |

In Rel-12, there are sixteen DCI formats. DCI format 1, 1A, 1B, 1C, 1D, 2, 2A, 2B, 2C, and 2D may be used for DL assignment (also referred to as DL grant). The DCI formats are illustrated in Table (2).

TABLE (2)

| DCI format | Use |
|---|---|
| DCI format 0 | scheduling of PUSCH in one UL cell |
| DCI format 1 | scheduling of one PDSCH codeword in one cell |
| DCI format 1A | compact scheduling of one PDSCH codeword in one cell and |
| | random access procedure initiated by a PDCCH order |
| DCI format 1B | compact scheduling of one PDSCH codeword in one cell with |
| | precoding information |
| DCI format 1C | very compact scheduling of one PDSCH codeword, notifying |
| | MCCH change, and reconfiguring TDD |
| DCI format 1D | compact scheduling of one PDSCH codeword in one cell with |
| | precoding and power offset information |
| DCI format 1A | Transmit diversity |
| DCI format 2 | scheduling of up to two PDSCH codewords in one cell with |
| | precoding information |
| DCI format 2A | scheduling of up to two PDSCH codewords in one cell |
| DCI format 2B | scheduling of up to two PDSCH codewords in one cell with |
| | scrambling identity information |
| DCI format 2C | scheduling of up to two PDSCH codewords in one cell with antenna |
| | port, scrambling identity and number of layers information |
| DCI format 2D | scheduling of up to two PDSCH codewords in one cell with antenna |
| | port, scrambling identity and number of layers information and |
| | PDSCH RE Mapping and Quasi-Co-Location Indicator (PQI) |
| | information |
| DCI format 3 | transmission of TPC commands for PUCCH and PUSCH with 2-bit |
| | power adjustments |
| DCI format 3A | transmission of TPC commands for PUCCH and PUSCH with |
| | single bit power adjustments |
| DCI format 4 | of PUSCH in one UL cell with multi-antenna port transmission |
| | mode |
| DCI format 5 | scheduling of PSCCH, and also contains several SCI format 0 fields |
| | used for the scheduling of PSSCH |

DCI format 1, 1A, 1B, 1C, 1D may include the bit fields provided in Table (3), where NDLRB is a downlink system band width of the serving cell, which is expressed in multiples of PRB (physical resource block) bandwidth.

TABLE (3)

| | DCI F 1 | DCI F 1A | DCI F 1B | DCI F 1C | DCI F 1D |
|---|---|---|---|---|---|
| CIF | 0 or 3 | 0 or 3 | 0 or 3 | N/A | 0 or 3 |
| Flag for format0/1A | N/A | 1 | N/A | N/A | N/A |
| differentiation | | | | | |
| Localized/Distributed | N/A | 1 | 1 | N/A | 1 |
| VRB assignment flag | | | | | |
| Resource allocation | 1 | N/A | N/A | N/A | N/A |
| header | | | | | |
| Gap value | N/A | N/A | N/A | 0 | N/A |
| | | | | (N^{DL}_{RB} <50) | |
| | | | | or 1 | |
| | | | | (otherwise) | |
| Resource block | * | ** | ** | *** | ** |
| assignment | | | | | |
| Modulation and | 5 | 5 | 5 | 5 | 5 |
| coding scheme | | | | | |
| HARQ process | 3 (FDD | 3 (FDD | 3 (FDD | N/A | 3 (FDD |
| number | PCell) or 4 | PCell) or 4 | PCell) or 4 | | PCell) or 4 |
| | (TDD | (TDD | (TDD | | (TDD |
| | PCell) | PCell) | PCell) | | PCell) |
| New data indicator | 1 | 1 | 1 | N/A | 1 |
| Redundancy version | 2 | 2 | 2 | N/A | 2 |
| TPC command for | 2 | 2 | 2 | N/A | 2 |
| PUCCH | | | | | |
| Downlink | 0 (FDD | 0 (FDD | 0 (FDD | N/A | 0 (FDD |
| Assignment Index | PCell) or 2 | PCell) or 2 | PCell) or 2 | | PCell) or 2 |
| | (otherwise) | (otherwise) | (otherwise) | | (otherwise) |
| SRS request | N/A | 0 or 1 | N/A | N/A | N/A |
| Downlink power | N/A | N/A | N/A | N/A | 1 |
| offset | | | | | |
| TPMI information | N/A | N/A | 2 (2 CRS | N/A | 2 (2 CRS |
| for precoding | | | ports) or 4 | | ports) or 4 |
| | | | (4 CRS | | (4 CRS |
| | | | ports) | | ports) |
| HARQ-ACK | 2 | 2 | 2 | N/A | 2 |
| resource offset | (EPDCCH) | (EPDCCH) | (EPDCCH) | | (EPDCCH) |
| | or 0 | or 0 | or 0 | | or 0 |
| | (PDCCH) | (PDCCH) | (PDCCH) | | (PDCCH) |

It should be noted that * is ceil(N^{DL}_{RB}/P) bits, where P is determined from Table (4); ** is ceil(log₂(N^{DL}_{RB}(N^{DL}_{RB}+1)/2)) bits; and *** is ceil(log₂(floor(N^{DL}_{VRB,gap1}/N^{step}_{RB})(floor(N^{DL}_{VRB,gap1}/N^{step}_{RB})+1)/2)) bits, where N^{DL}_{VRB,gap1}=2*min(N_{gap}, N^{DL}_{RB}−N_{gap}).

TABLE (4)

| System BW | |
|---|---|
| N^{DL}_{RB} | PRG size P |
| <=10 | 1 |
| 11-26 | 2 |
| 27-63 | 3 |
| 64-110 | 4 |

TABLE (5)

| System BW | |
|---|---|
| N^{DL}_{RB} | N^{step} RB |
| 6-49 | 2 |
| 50-110 | 4 |

DCI format 2, 2A, 2B, 2C, 2D may include the bit fields provided in Table (6).

TABLE (6)

| | DCI F 2 | DCI F 2A | DCI F 2B | DCI F 2C | DCI F 2D |
|---|---|---|---|---|---|
| CIF | 0 or 3 | 0 or 3 | 0 or 3 | 0 or 3 | 0 or 3 |
| Resource | 1 | 1 | 1 | 1 | 1 |
| allocation header | | | | | |
| Resource block | * | * | * | * | * |
| assignment | | | | | |
| TPC command for | 2 | 2 | 2 | 2 | 2 |
| PUCCH | | | | | |
| Downlink | 0 (FDD | 0 (FDD | 0 (FDD | 0 (FDD | 0 (FDD |
| Assignment Index | PCell) or 2 | PCell) or 2 | PCell) or 2 | PCell) or 2 | PCell) or 2 |
| | (otherwise) | (otherwise) | (otherwise) | (otherwise) | (otherwise) |
| HARQ process | 3 (FDD | 3 (FDD | 3 (FDD | 3 (FDD | 3 (FDD |
| number | PCell) or 4 | PCell) or 4 | PCell) or 4 | PCell) or 4 | PCell) or 4 |
| | (TDD | (TDD | (TDD | (TDD | (TDD |
| | PCell) | PCell) | PCell) | PCell) | PCell) |
| Scrambling | N/A | N/A | 1 | N/A | N/A |
| identity | | | | | |
| Antenna port, | N/A | N/A | N/A | 3 | 3 |
| scrambling | | | | | |
| identity and | | | | | |
| number of layers | | | | | |
| SRS request | N/A | N/A | 0 or 1 | 0 or 1 | N/A |
| Transport block to | 1 | 1 | N/A | N/A | |
| codeword swap | | | | | |
| flag | | | | | |
| Modulation and | 5 | 5 | 5 | 5 | 5 |
| coding scheme | | | | | |
| (TB1) | | | | | |
| New data | 1 | 1 | 1 | 1 | 1 |
| indicator (TB1) | | | | | |
| Redundancy | 2 | 2 | 2 | 2 | 2 |
| version (TB1) | | | | | |
| Modulation and | 5 | 5 | 5 | 5 | 5 |
| coding scheme | | | | | |
| (TB2) | | | | | |
| New data | 1 | 1 | 1 | 1 | 1 |
| indicator (TB2) | | | | | |
| Redundancy | 2 | 2 | 2 | 2 | 2 |
| version (TB2) | | | | | |
| PDSCH RE | N/A | N/A | N/A | N/A | 2 |
| Mapping and | | | | | |
| Quasi-Co- | | | | | |
| Location Indicator | | | | | |
| Precoding | 3 (2 CRS | 0 (2 CRS | N/A | N/A | N/A |
| information | ports) or 6 | ports) or 2 | | | |
| | (4 CRS | (4 CRS | | | |
| | ports) | ports) | | | |
| HARQ-ACK | 2 | 2 | 2 | 2 | 2 |
| resource offset | (EPDCCH) | (EPDCCH) | (EPDCCH) | (EPDCCH) | (EPDCCH) |
| | or 0 | or 0 | or 0 | or 0 | or 0 |
| | (PDCCH) | (PDCCH) | (PDCCH) | (PDCCH) | (PDCCH) |

The UE's 102 MAC procedure may include the following operations. DL-SCH data transfer may include DL assignment reception and HARQ operation. For the DL assignment reception, downlink assignments transmitted on the PDCCH indicate if there is a transmission on a DL-SCH for a particular MAC entity and provide the relevant HARQ information.

For the HARQ operation, there may be one HARQ entity at the MAC entity for each serving cell that maintains a number of parallel HARQ processes. Each HARQ process may be associated with a HARQ process identifier. The HARQ entity may direct HARQ information and associated TBs received on the DL-SCH to the corresponding HARQ processes. If a downlink assignment has been indicated for this TTI, the MAC entity may allocate the TB(s) received from the physical layer and the associated HARQ information to the HARQ process indicated by the associated HARQ information. If this is a new transmission, the MAC entity may then attempt to decode the received data. If this is a retransmission, the MAC entity may then combine the received data with the data currently in the soft buffer for this TB and attempts to decode the combined data.

The UE's 102 MAC procedure may also include UL-SCH data transfer. This may include a UL grant reception; HARQ operation; and multiplexing and assembly. For UL grant reception, in order to transmit on the UL-SCH the MAC entity must have a valid uplink grant (except for non-adaptive HARQ retransmissions) which it may receive dynamically on the PDCCH or in a random access response or which may be configured semi-persistently. To perform requested transmissions, the MAC layer may receive HARQ information from lower layers. When the physical layer is configured for uplink spatial multiplexing, the MAC layer may receive up to two grants (one per HARQ process) for the same TTI from lower layers.

For HARQ operation, there may be one HARQ entity at the MAC entity for each serving cell with a configured uplink, which maintains a number of parallel HARQ processes allowing transmissions to take place continuously while waiting for the HARQ feedback on the successful or unsuccessful reception of previous transmissions. At a given TTI, if an uplink grant is indicated for the TTI, the HARQ entity may identify the HARQ process(es) for which a transmission should take place. It may also route the received HARQ feedback (i.e., ACK/NACK information), MCS and resource, relayed by the physical layer, to the appropriate HARQ process(es). For each TTI, the HARQ entity may identify the HARQ process(es) associated with this TTI.

For multiplexing and assembly, RRC may control the scheduling of uplink data by signaling for each logical channel. An increasing priority value may indicate a lower priority level, prioritisedBitRate may set the prioritized bit rate (PBR), bucketSizeDuration may set the bucket size duration (BSD).

The MAC entity may maintain a variable Bj for each logical channel j. Bj may be initialized to zero when the related logical channel is established, and may be incremented by the product PBR×TTI duration for each TTI, where PBR is the prioritized bit rate of logical channel j. However, the value of Bj may never exceed the bucket size and if the value of Bj is larger than the bucket size of logical channel j, Bj may be set to the bucket size. The bucket size of a logical channel is equal to PBR×BSD, where PBR and BSD are configured by upper layers.

When a scheduling request (SR) is triggered, it may be considered as pending until it is cancelled. All pending SR(s) may be cancelled and sr-ProhibitTimer may be stopped when a MAC PDU is assembled and this PDU includes a BSR that contains a buffer status up to (and including) the last event that triggered a BSR or, if all pending SR(s) are triggered by a sidelink BSR, when a MAC PDU is assembled and this PDU includes a sidelink BSR which contains buffer status up to (and including) the last event that triggered a sidelink BSR, or, if all pending SR(s) are triggered by a sidelink BSR, when upper layers configure autonomous resource selection, or when the UL grant(s) can accommodate all pending data available for transmission.

A buffer status reporting procedure may be used to provide the serving eNB 160 with information about the amount of data available for transmission in the UL buffers associated with the MAC entity. RRC controls BSR reporting by configuring three timers (e.g., periodicBSR-Timer, retxBSR-Timer and logicalChannelSR-ProhibitTimer) and by, for each logical channel, optionally signaling logicalChannelGroup, which allocates the logical channel to an LCG.

A power headroom reporting procedure may be used to provide the serving eNB 160 with information about the difference between the nominal UE maximum transmit power and the estimated power for UL-SCH transmission per activated serving cell and also with information about the difference between the nominal UE maximum power and the estimated power for UL-SCH and PUCCH transmission on a SpCell.

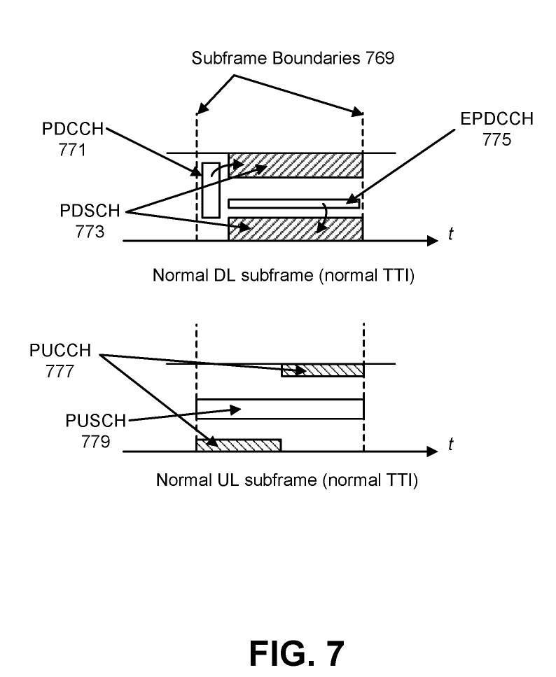

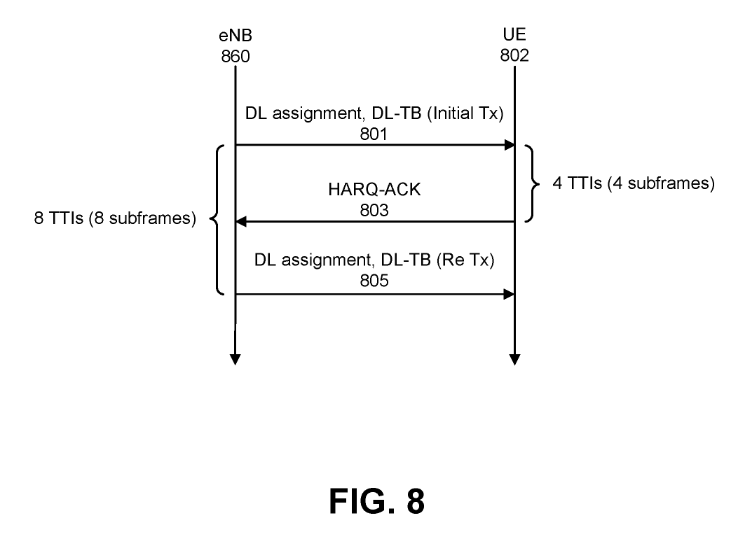

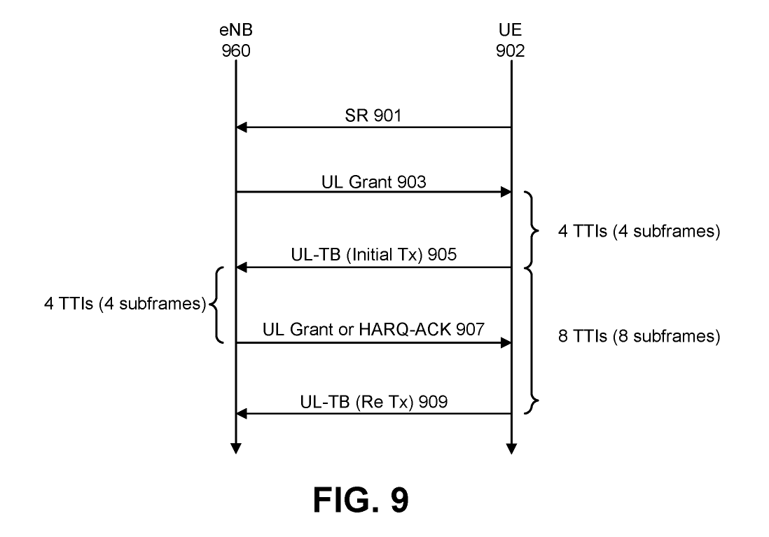

The UE reduced latency module 126 may reduce latency through the use of a shortened transmission timing interval (TTI) and/or a shortened round trip time (RTT). In an implementation, the UE 102 may be configured to use a shortened transmission timing interval (TTI) for an SCG and a normal TTI for a MCG. For normal TTI, one TTI corresponds to one subframe, as is explained above. For example, for normal CP, one TTI consists of 14 OFDM symbols. An example of a physical channel structure for the normal TTI is described in connection with FIG. 7. An example of a retransmission cycle of a DL transport block (DL-TB) is described in connection with FIG. 8. An example of a retransmission cycle of a UL transport block (UL-TB) is described in connection with FIG. 9.

The length of a shortened TTI may be shorter than the normal TTI (e.g., 2-OFDM-symbol-long TTI, 1-slot-long TTI). The shortened TTI may include 2 OFDM symbols. A first OFDM symbol of the two OFDM symbols may contain a physical control channel. A second OFDM symbol of the two OFDM symbols may contain a physical shared channel. The shortened TTI may bring a reduction of physical layer latency, since L1 and L2 functions may be operated with a TTI basis.

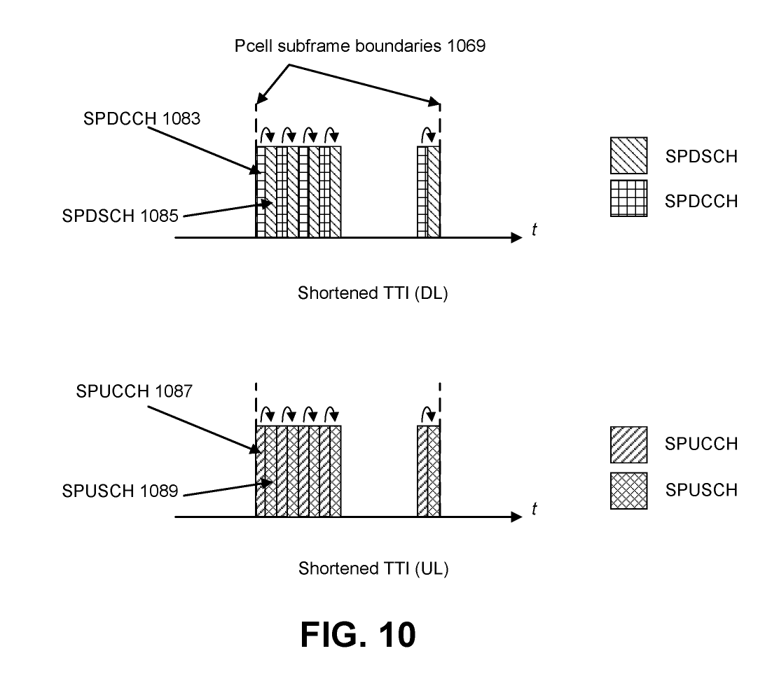

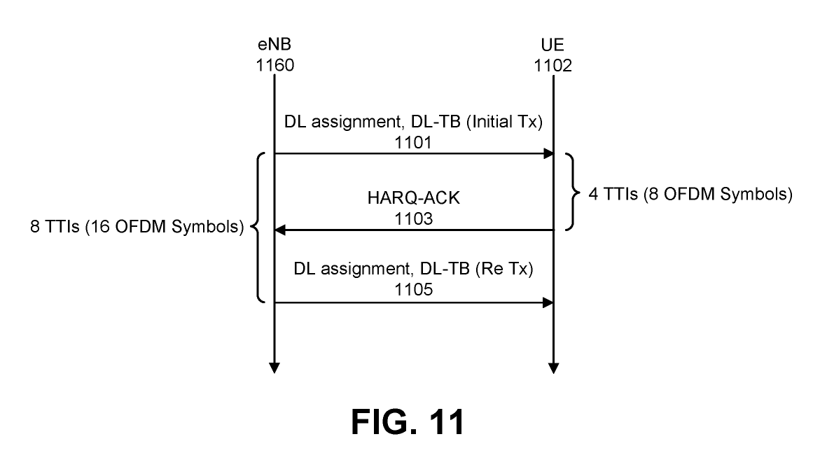

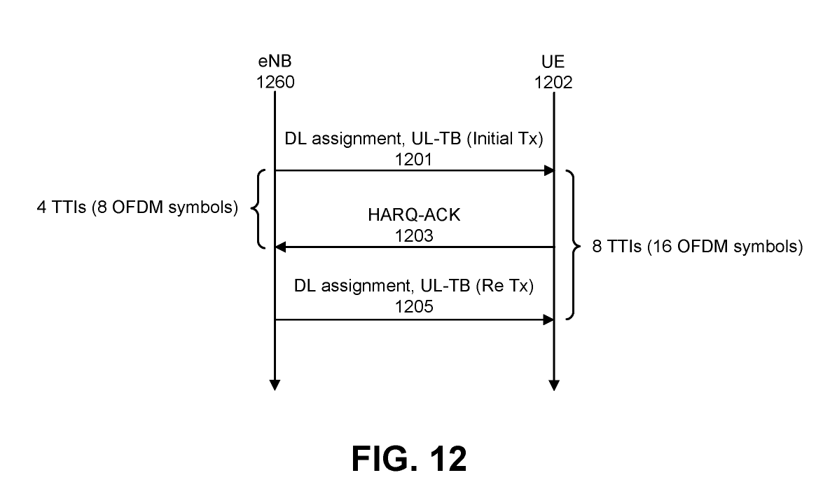

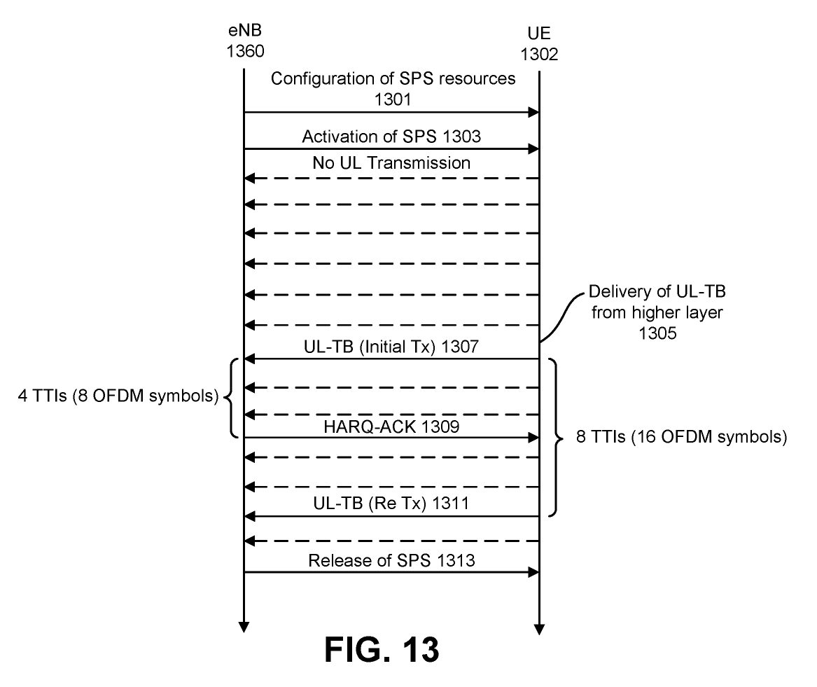

An example of a physical channel structure for the shortened TTI is described in connection with FIG. 10. An example of a retransmission cycle of a DL-TB in case of shortened TTI is described in connection with FIG. 11. Examples of a retransmission cycle of a UL-TB in a case of shortened TTI are described in connection with FIGS. 12 and 13.

The shortened TTI may be configured per serving cell via dedicated RRC message. Whether or not the shortened TTI is applied may be configured per cell group (e.g., a PUCCH cell group or a DC cell group) via dedicated RRC message. Instead of configuration of the shortened TTI, any other configuration may be used. In this case, it may be determined which TTI is used (between the normal TTI or the shortened TTI) according to that configuration. It should be noted that in an MCG, the normal TTI may be used irrespective of whether or not the shortened TTI is configured for SCG.

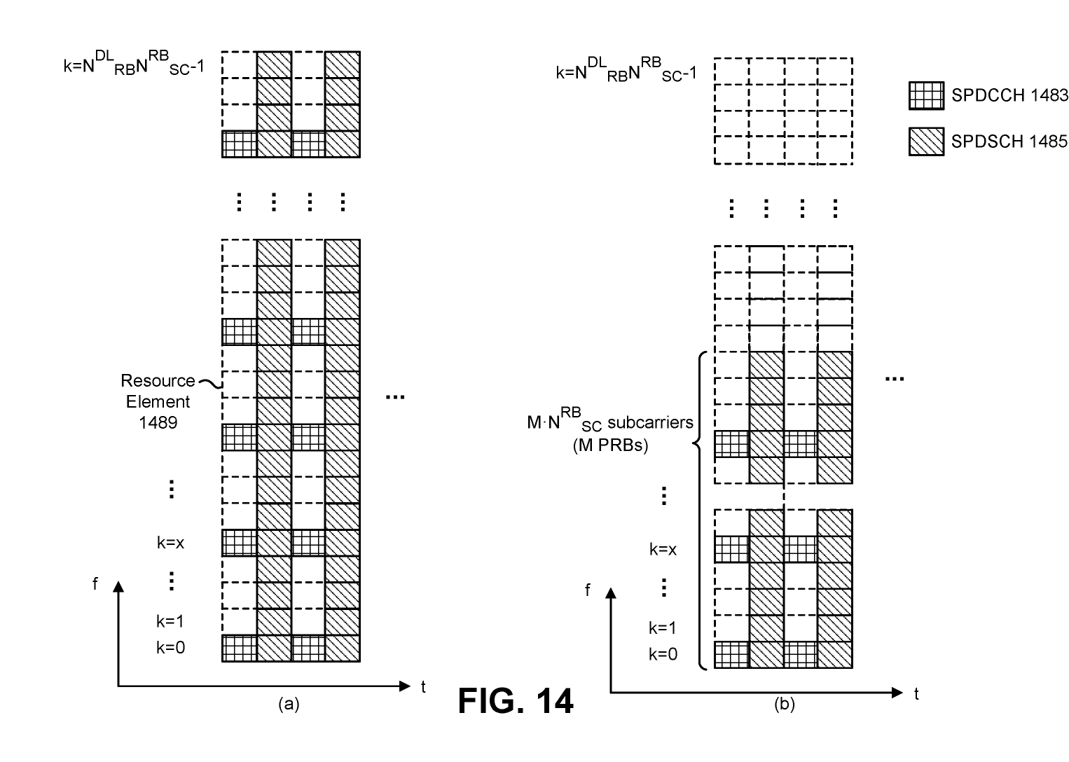

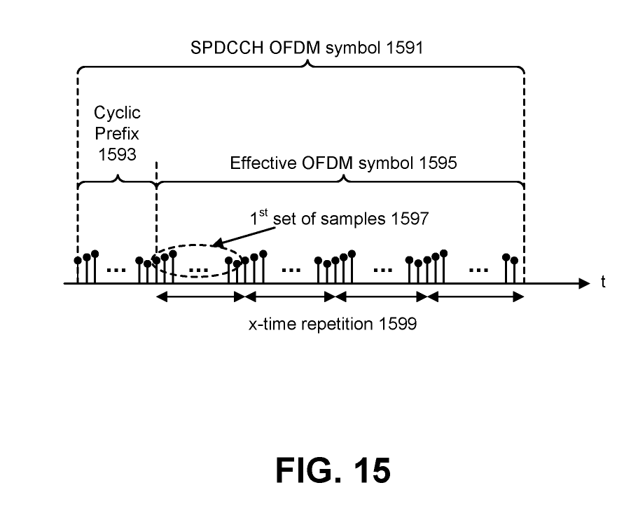

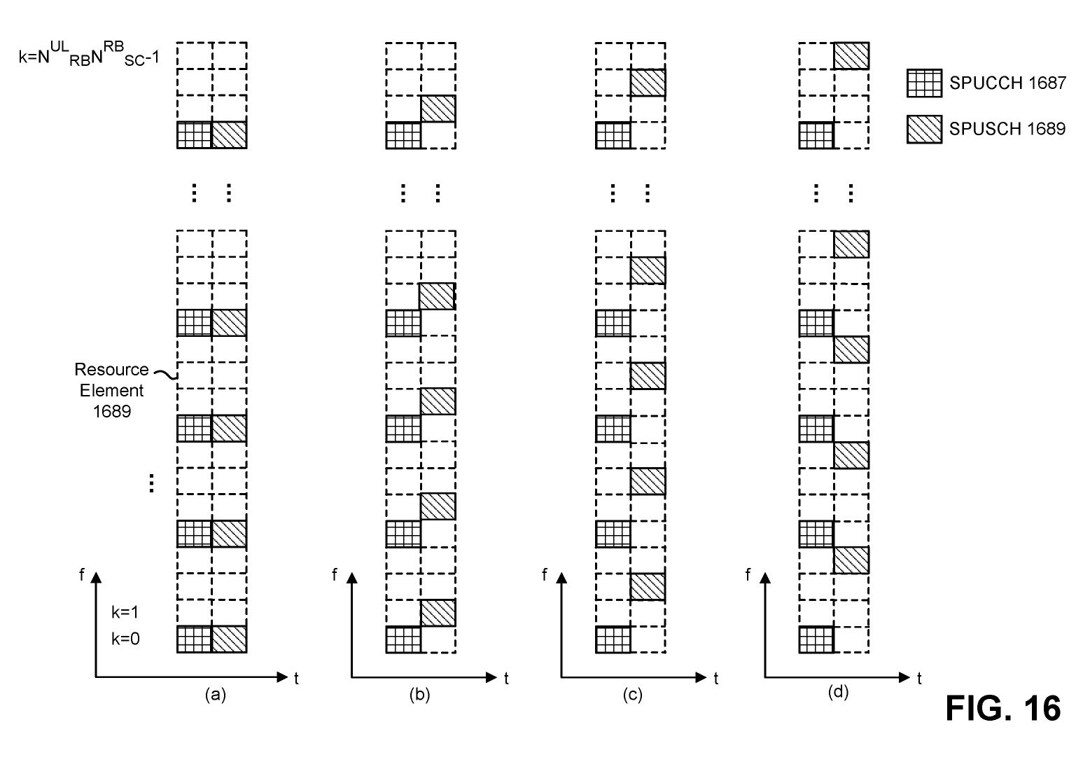

Examples of RE mapping of SPDCCH and SPDSCH are described in connection with FIG. 14. An example of a time domain signal of SPDCCH is described in connection with FIG. 15. Examples of RE mapping of SPUCCH and SPUSCH are described in connection with FIG. 16.

While a 2-OFDM-symbol-long shortened TTI is described herein, other options may be used. For example, 3-OFDM symbols, 4-OFDM symbols, and slot-base shortened TTI (i.e. 0.5 ms-long TTI) may be used. Also in this instance, a DL TTI can include SPDCCH and SPDSCH while a UL TTI can include SPUCCH and SPUSCH.

Another solution to reduce latency is a shortened round trip time (RTT). In an implementation of shortened RTT, an interval between TB reception and HARQ-ACK transmission may be shorter than that of the normal RTT. In another implementation of shortened RTT, an interval between HARQ-ACK reception and TB retransmission may be shorter than that of the normal RTT. In yet another implementation of shortened RTT, both of these intervals are shorter. These implementations may use faster processing.

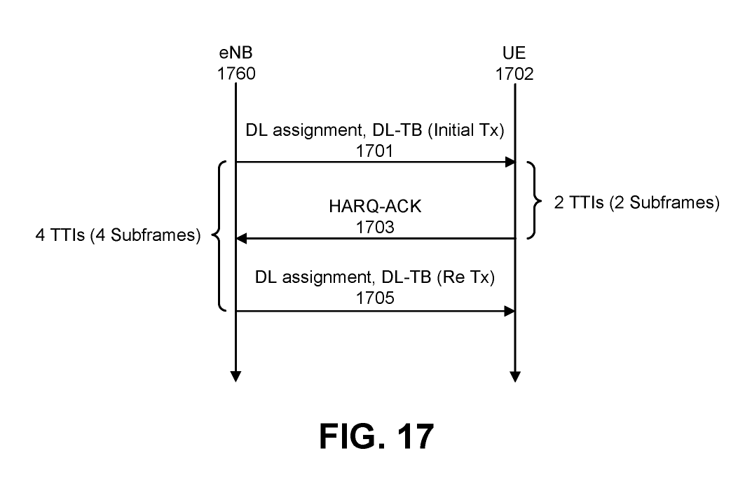

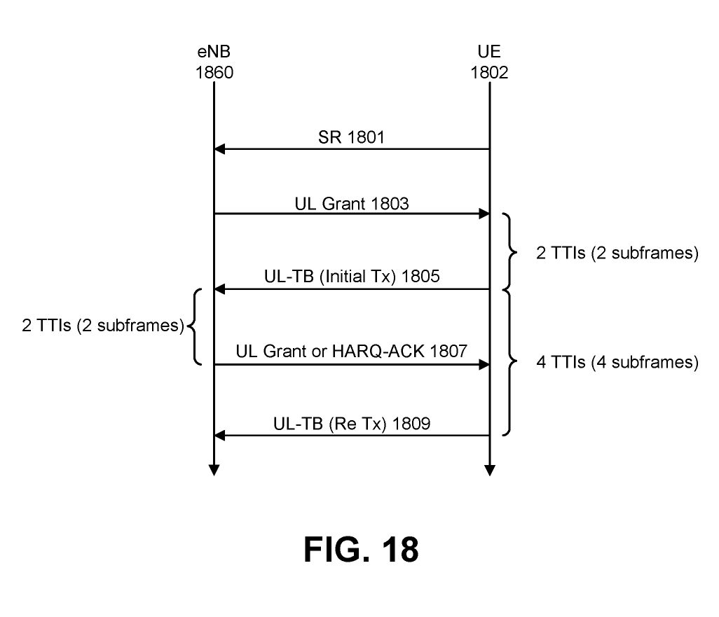

A retransmission cycle of a DL-TB with the shortened RTT is described in connection with FIG. 17. A retransmission cycle of a UL-TB with the shortened RTT is described in connection with FIG. 18.

The above-described shortened TTI and shortened RTT may be applied independently. Alternatively, they can be applied simultaneously.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB reduced latency module 194.

The eNB reduced latency module 194 may reduce latency through the use of a shortened transmission timing interval (TTI) and/or a shortened round trip time (RTT). In an implementation, the eNB reduced latency module 194 may configure an SCG in a UE 102. The eNB reduced latency module 194 may configure a shortened TTI for the SCG. The eNB 160 may use a normal TTI for an MCG and the shortened TTI for the SCG. This may be accomplished as described above.

In another implementation, the eNB reduced latency module 194 may reduce latency through the use of a shortened RTT. The eNB reduced latency module 194 may configure a shortened RTT for the SCG. The eNB 160 may use a normal RTT for an MCG and the shortened RTT for the SCG. This may be accomplished as described above.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode information 101, including transmission data 105.

The encoder 109 may encode transmission data 105 and/or other information included in the information 101 provided by the eNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. In some implementations, this may be based on the PSS and SSS. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

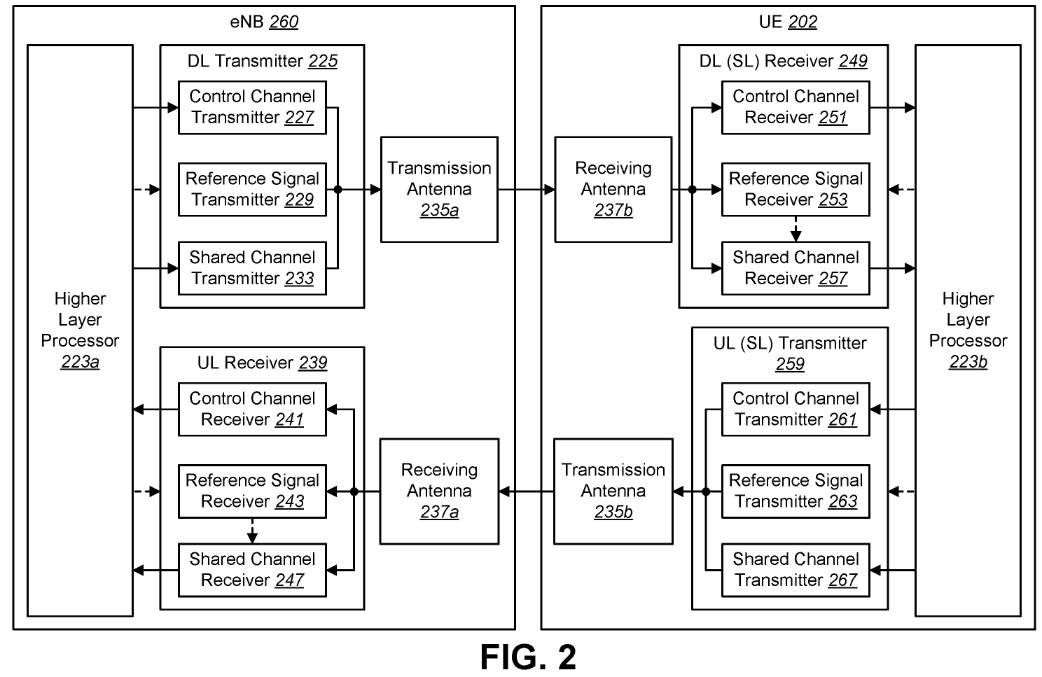

FIG. 2 is block diagram illustrating a detailed configuration of an eNB 260 and a UE 202 in which systems and methods for low latency radio communications may be implemented. The eNB 260 may include a higher layer processor 223a a DL transmitter 225 and a UL receiver 239. The higher layer processor 223a may communicate with the DL transmitter 225, UL receiver 239 and subsystems of each.

The DL transmitter 225 may include a control channel transmitter 227, a reference signal transmitter 229 and a shared channel transmitter 233. The DL transmitter 225 may transmit signals/channels to the UE 202 using a transmission antenna 235a.

The UL receiver 239 may include a control channel receiver 241, a reference signal receiver 243 and a shared channel receiver 247. The UL receiver 239 may receive signals/channels from the UE 202 using a receiving antenna 237a. The reference signal receiver 243 may provide signals to the shared channel receiver 247 based on the received reference signals.

The eNB 260 may configure, in the UE 202, a secondary cell group (SCG) and may use a shortened TTI and/or shortened RTT on the SCG. The configurations may be performed by the higher layer processor 223a.

Upon the configuration, the eNB 260 may use a normal TTI and/or normal RTT and the shortened TTI and/or shortened RTT for the master cell group (MCG) and the SCG respectively. More specifically, physical channels (e.g., PDCCH, EPDCCH and PDSCH) on the MCG may be transmitted using the normal TTI and/or normal RTT while physical channels (e.g., SPDCCH and SPDSCH) on the SCG may be transmitted using the shortened TTI and/or shortened RTT. These physical channel transmissions may be performed by the physical channel transmitter (also referred to as DL transmitter 225). Furthermore, physical channels (e.g., PUCCH and PUSCH) on the MCG may be received using a normal TTI and/or normal RTT while physical channels (e.g., SPUCCH and SPUSCH) on the SCG may be received using the shortened TTI and/or shortened RTT. These physical channel receptions may be performed by the physical channel receiver (also referred to as UL receiver 239).

The higher layer processor 223a may manage two MAC entities. One of the MAC entities may correspond to MCG and the other may correspond to SCG. In the MAC entity corresponding to the MCG, a DL-SCH data transfer procedure (e.g., DL assignment transmission, DL HARQ operation, multiplexing and so on) and a UL-SCH data transfer procedure (e.g., UL grant reception, UL HARQ operation, demultiplexing and so on) may be performed by using the normal TTI and/or normal RTT. In the MAC entity corresponding to the SCG, a DL-SCH data transfer procedure may be performed by using the shortened TTI and/or shortened RTT.

The UE 202 may include a higher layer processor 223b a DL (SL) receiver 249 and a UL (SL) transmitter 259. The higher layer processor 223b may communicate with the DL (SL) receiver 249, UL (SL) transmitter 259 and subsystems of each.

The DL (SL) receiver 249 may include a control channel receiver 251, a reference signal receiver 253 and a shared channel receiver 257. The DL (SL) receiver 249 may receive signals/channels from the UE 202 using a receiving antenna 237b. The reference signal receiver 253 may provide signals to the shared channel receiver 257 based on the received reference signals. For example, the shared channel receiver 257 may be configured to receive the PDSCH for which the same antenna port is used as for the reference signals.

The UL (SL) transmitter 259 may include a control channel transmitter 261 and a shared channel transmitter 267. The UL (SL) transmitter 259 may send signals/channels to the eNB 260 using a transmission antenna 235b.

The UE 202 may configure, based on a dedicated RRC message from the eNB 260, the SCG and a use of shortened TTI and/or shortened RTT on the SCG. The configurations may be performed by the higher layer processor 223b.

Upon the configuration, the UE 202 may use the normal TTI and/or normal RTT and the shortened TTI and/or shortened RTT for the MCG and the SCG respectively. More specifically, physical channels (e.g., PDCCH, EPDCCH and PDSCH) on the MCG may be received using a normal TTI and/or normal RTT while physical channels (e.g., SPDCCH and SPDSCH) on the SCG may be received using the shortened TTI and/or shortened RTT. These physical channel receptions may be performed by the physical channel receiver (also referred to as DL receiver). Furthermore, physical channels (e.g., PUCCH and PUSCH) on the MCG may be transmitted using a normal TTI and/or a normal RTT while physical channels (e.g., SPUCCH and SPUSCH) on the SCG may be transmitted using the shortened TTI and/or shortened RTT. These physical channel transmissions may be performed by the physical channel transmitter (also referred to as UL transmitter).

The higher layer processor 223b may manage two MAC entities. One of them may correspond to the MCG and the other may correspond to the SCG. In the MAC entity corresponding to the MCG, a DL-SCH data transfer procedure (e.g., DL assignment reception, DL HARQ operation, demultiplexing and so on) and a UL-SCH data transfer procedure (e.g., UL grant transmission, UL HARQ operation, multiplexing and so on) may be performed by using the normal TTI and/or normal RTT. In the MAC entity corresponding to the SCG, a DL-SCH data transfer procedure may be performed by using the shortened TTI and/or shortened RTT.

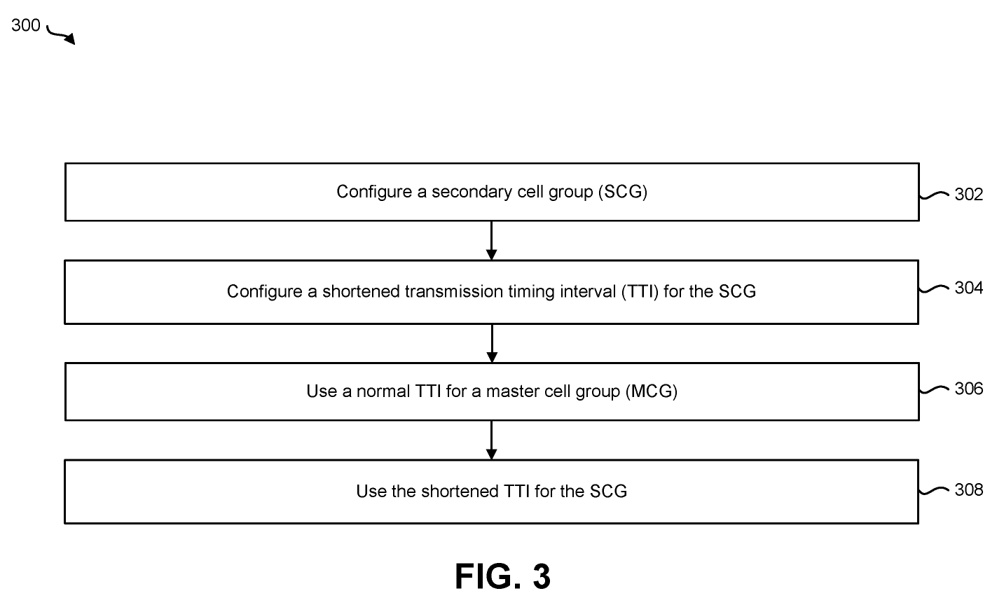

FIG. 3 is a flow diagram illustrating a method 300 for low latency radio communications by a UE 102. The UE 102 may configure 302 a secondary cell group (SCG). The UE 102 may also configure 304 a shortened transmission timing interval (TTI) for the SCG. For example, the UE 102 may configure, based on a dedicated RRC message from an eNB 102, the SCG and use of a shortened TTI on the SCG. The configurations may be performed by a higher layer processor.

The shortened TTI may include 2 OFDM symbols. A first OFDM symbol of the two OFDM symbols may contain a physical control channel. The physical control channel may be mapped on discrete subcarriers of which frequency intervals are uniform. A second OFDM symbol of the two OFDM symbols may contain a physical shared channel.

Upon the configuration, the UE 102 may use 306 the normal TTI for the MCG and use 308 the shortened TTI for the SCG. For example, physical channels (e.g., PDCCH, EPDCCH and PDSCH) on the MCG may be received using a normal TTI while physical channels (e.g., SPDCCH and SPDSCH) on the SCG may be received using the shortened TTI. These physical channel receptions may be performed by a physical channel receiver (also referred to as DL receiver).

Furthermore, physical channels (e.g., PUCCH and PUSCH) on the MCG may be transmitted using a normal TTI while physical channels (e.g., SPUCCH and SPUSCH) on the SCG may be transmitted using the shortened TTI. These physical channel transmissions may be performed by physical channel transmitter (also referred to as UL transmitter).

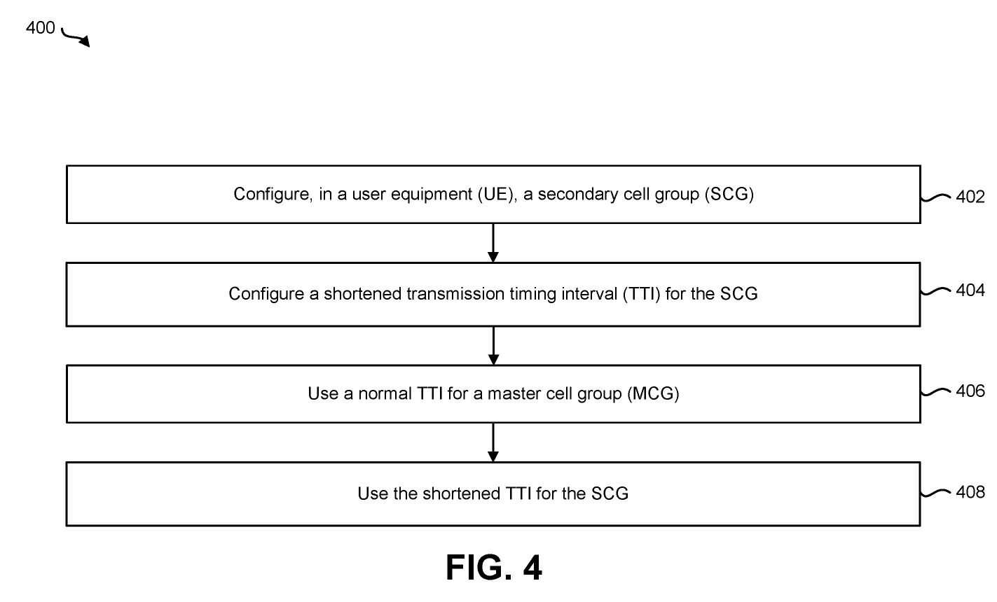

FIG. 4 is a flow diagram illustrating a method 400 for low latency radio communications by an eNB 160. The eNB 160 may configure 402 a secondary cell group (SCG) in a UE 102. The eNB 160 may also configure 404 a shortened transmission timing interval (TTI) for the SCG. For example, the eNB 160 may configure, based on a dedicated RRC message from an eNB 102, the SCG and use of a shortened TTI on the SCG. The configurations may be performed by a higher layer processor.

The shortened TTI may include 2 OFDM symbols. A first OFDM symbol of the two OFDM symbols may contain a physical control channel. The physical control channel may be mapped on discrete subcarriers of which frequency intervals are uniform. A second OFDM symbol of the two OFDM symbols may contain a physical shared channel.

Upon the configuration, the eNB 160 may use 406 the normal TTI for the MCG and may use 408 the shortened TTI for the SCG. This may be accomplished as described in connection with FIG. 3.

FIG. 5 is a diagram illustrating one example of a radio frame 535 that may be used in accordance with the systems and methods disclosed herein. This radio frame 535 structure illustrates a TDD structure. Each radio frame 535 may have a length of T_{f}=307200·Tₛ=10 ms, where T_{f} is a radio frame 535 duration and Tₛ is a time unit equal to 1/(15000×2048) seconds. The radio frame 535 may include two half-frames 533, each having a length of 153600·Tₛ=5 ms. Each half-frame 533 may include five subframes 523a-e, 523f-j each having a length of 30720·Tₛ=1 ms.

TDD UL/DL configurations 0-6 are given below in Table (7) (from Table 4.2-2 in 3GPP TS 36.211). UL/DL configurations with both 5 millisecond (ms) and 10 ms downlink-to-uplink switch-point periodicity may be supported. In particular, seven UL/DL configurations are specified in 3GPP specifications, as shown in Table (7) below. In Table (7), “D” denotes a downlink subframe, “S” denotes a special subframe and “U” denotes a UL subframe.

TABLE 7

| | Downlink-to- | | | | | | | | | | |
|---|---|---|---|---|---|---|---|---|---|---|---|
| TDD UL/DL | Uplink | | | | | | | | | | |
| Configuration | Switch-Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table (7) above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table (8) (from Table 4.2-1 of 3GPP TS 36.211) subject to the total length of DwPTS, GP and UpPTS being equal to 30720·Tₛ=1 ms. In Table (8), “cyclic prefix” is abbreviated as “CP” and “configuration” is abbreviated as “Config” for convenience.

TABLE 8

| | Normal CP in downlink | | | Extended CP in downlink | | |
|---|---|---|---|---|---|---|
| Special | | UpPTS | | | UpPTS | |
| Subframe | | Normal CP | Extended CP | | Normal CP | Extended CP |
| Config | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

UL/DL configurations with both 5 ms and 10 ms downlink-to-uplink switch-point periodicity are supported. In the case of 5 ms downlink-to-uplink switch-point periodicity, the special subframe exists in both half-frames. In the case of 10 ms downlink-to-uplink switch-point periodicity, the special subframe exists in the first half-frame only. Subframes 0 and 5 and DwPTS may be reserved for downlink transmission. UpPTS and the subframe immediately following the special subframe may be reserved for uplink transmission.

In accordance with the systems and methods disclosed herein, some types of subframes 523 that may be used include a downlink subframe, an uplink subframe and a special subframe 531. In the example illustrated in FIG. 5, which has a 5 ms periodicity, two standard special subframes 531a-b are included in the radio frame 535. The remaining subframes 523 are normal subframes 537.

The first special subframe 531a includes a downlink pilot time slot (DwPTS) 525a, a guard period (GP) 527a and an uplink pilot time slot (UpPTS) 529a. In this example, the first standard special subframe 531a is included in subframe one 523b. The second standard special subframe 531b includes a downlink pilot time slot (DwPTS) 525b, a guard period (GP) 527b and an uplink pilot time slot (UpPTS) 529b. In this example, the second standard special subframe 531b is included in subframe six 523g. The length of the DwPTS 525a-b and UpPTS 529a-b may be given by Table 4.2-1 of 3GPP TS 36.211 (illustrated in Table (8) above) subject to the total length of each set of DwPTS 525, GP 527 and UpPTS 529 being equal to 30720·Tₛ=1 ms.

Each subframe i 523a-j (where i denotes a subframe ranging from subframe zero 523a (e.g., 0) to subframe nine 523j (e.g., 9) in this example) is defined as two slots, 2i and 2i+1 of length Tₛₗₒₜ=15360·Tₛ=0.5 ms in each subframe 523. For example, subframe zero (e.g., 0) 523a may include two slots, including a first slot.

UL/DL configurations with both 5 ms and 10 ms downlink-to-uplink switch-point periodicity may be used in accordance with the systems and methods disclosed herein. FIG. 5 illustrates one example of a radio frame 535 with 5 ms switch-point periodicity. In the case of 5 ms downlink-to-uplink switch-point periodicity, each half-frame 533 includes a standard special subframe 531a-b. In the case of 10 ms downlink-to-uplink switch-point periodicity, a special subframe 531 may exist in the first half-frame 533 only.

Subframe zero (e.g., 0) 523a and subframe five (e.g., 5) 523f and DwPTS 525a-b may be reserved for downlink transmission. The UpPTS 529a-b and the subframe(s) immediately following the special subframe(s) 531a-b (e.g., subframe two 523c and subframe seven 523h) may be reserved for uplink transmission. It should be noted that, in some implementations, special subframes 531 may be considered DL subframes in order to determine a set of DL subframe associations that indicate UCI transmission uplink subframes of a UCI transmission cell.

FIG. 6 is a diagram illustrating one example of a resource grid. The resource grid illustrated in FIG. 6 may be utilized in some implementations of the systems and methods disclosed herein. More detail regarding the resource grid is given in connection with FIG. 1.

In FIG. 6, one downlink subframe 669 may include two downlink slots 683. N^{DL}_{RB} is downlink bandwidth configuration of the serving cell, expressed in multiples of N^{RB}_{sc}, where N^{RB}_{sc} is a resource block 687 size in the frequency domain expressed as a number of subcarriers, and N^{DL}_{symb} is the number of OFDM symbols in a downlink slot 683. A resource block 687 may include a number of resource elements (RE) 689.

For a PCell, N^{DL}_{RB} is broadcast as a part of system information. For an SCell (including an LAA SCell), N^{DL}_{RB} is configured by a RRC message dedicated to a UE 102. For PDSCH mapping, the available RE 689 may be the RE 689 whose index 1 fulfils 1≧1_{data,start} and/or 1_{data,end}≧1 in a subframe.

FIG. 7 illustrates an example of a physical channel structure for a normal TTI. In an implementation, the TTI duration on an SCell may be defined by subframe boundaries 769 in the time domain. For downlink, PDCCH 771 is a physical downlink control channel mapped on the OFDM symbols that are located in the front part (e.g., the first OFDM symbol through the 4th OFDM symbol) of a subframe. EPDCCH 775 is another physical downlink control channel mapped on the OFDM symbols that are located in rear part (e.g., the 2nd OFDM symbol to the last OFDM symbol) of the subframe.

The PDCCH 771 or EPDCCH 775 may carry a downlink assignment that indicates a PDSCH 773 transmission. The PDSCH 773 may be mapped on the OFDM symbols that are located in the rear part (e.g., the 2nd OFDM symbol to the last OFDM symbol) of the subframe.

For uplink, PUCCH 777 is a physical uplink control channel mapped on the whole SC-FDMA symbols within a subframe but is mapped to different frequency resources in different slots of the subframe. PUSCH 779 is a physical uplink shared channel mapped on the whole SC-FDMA symbols within the subframe and is mapped to the resources that are relatively closer to the center frequency of the uplink system band than those for PUCCH 777.

FIG. 8 illustrates an example of a retransmission cycle of a DL transport block (DL-TB). When data transmission occurs in a higher layer at the eNB side, the eNB 860 may determine physical layer parameters (e.g., MCS, PRB assignment, etc.) for an initial transmission of the DL-TB. The eNB 860 may transmit 801 a DL assignment and the corresponding PDSCH 773 carrying the DL-TB(s) in the same subframe.

If the UE 802 detects PDCCH 771 or EPDCCH 775 carrying the DL assignment, the UE 802 may attempt to decode DL-TB in the corresponding PDSCH 773. If the UE 802 succeeds to decode DL-TB, then the UE 802 may report 803 ACK as the HARQ-ACK in the subframe 4-TTI later than the subframe carrying the DL assignment and DL-TB. Otherwise, the UE 802 reports 803 NACK as the HARQ-ACK in that subframe.

When the eNB 860 receives NACK, the eNB 860 re-transmits 805 the DL-TB in the subframe 4-TTI later than the subframe carrying HARQ-ACK. Similarly, the next retransmission may be performed in the subframe 8-TTI later than the subframe of the 1st retransmission. Eventually, the retransmission cycle is 8 TTIs. In other words, a given DL-TB may be transmitted in every 8 subframe at minimum as long as the UE 802 reports NACK for the DL-TB.

FIG. 9 illustrates an example of a retransmission cycle of a UL transport block (UL-TB). When data transmission occurs in a higher layer at the UE side, the UE 902 may send 901 a scheduling request (SR) or may initiate a random access channel (RACH) procedure instead of sending the SR.

If the eNB 960 receives the SR or finished the RACH procedure, the eNB 960 may determine physical layer parameters (e.g., MCS, PRB assignment, etc.) for an initial transmission of the UL-TB. The eNB 960 may transmit 903 an UL grant.

If the UE 902 detects PDCCH 771 or EPDCCH 775 carrying the UL grant, the UE 902 may transmit 905 PUSCH 779 containing the UL-TB in the subframe 4-TTI later than the subframe carrying the UL grant. The eNB 960 may attempt to decode the UL-TB.

If the UE 902 succeeds to decode DL-TB, then the eNB 960 may report 907 ACK as the HARQ-ACK or may send another UL grant scheduling a new UL-TB in the subframe 4-TTI later than the subframe carrying the UL-TB. Otherwise, the eNB 960 may report NACK as the HARQ-ACK or may send another UL grant scheduling the same UL-TB in that subframe.

When the UE 902 receives NACK or another UL grant scheduling the same UL-TB, the UE 902 may re-transmit 909 the UL-TB in the subframe 4-TTI later than the subframe carrying HARQ-ACK or the UL grant. Similarly, the next retransmission may be performed in the subframe 8-TTI later than the subframe of the 1st retransmission. Eventually, the retransmission cycle is 8 TTIs. In other words, a given UL-TB may be transmitted in every 8 subframe at minimum as long as the eNB 960 reports NACK or sends an UL grant initiating a retransmission for the UL-TB.

FIG. 10 illustrates an example of a physical channel structure for a shortened TTI. The shortened TTI duration on an SCell may be defined by PCell subframe boundaries 1069 in the time domain. In an implementation, the TTI duration on an SCell may be defined by a 2-OFDM-symbol length in the time domain.

For downlink, SPDCCH 1083 is a physical downlink control channel mapped on the OFDM symbol is one of even-numbered OFDM symbols within a subframe. The SPDCCH 1083 may carry a downlink assignment that indicates a SPDSCH 1085 transmission. The SPDSCH may be mapped on the OFDM symbol that is one of odd-numbered OFDM symbols within the subframe.

For uplink, SPUCCH 1087 is a physical uplink control channel mapped on one of the even-numbered SC-FDMA symbols within a subframe. SPUSCH 1089 is a physical uplink shared channel mapped on one of the odd-numbered SC-FDMA symbols within the subframe. With these structures, the TTI length becomes much shorter than the normal TTI.

FIG. 11 illustrates an example of a retransmission cycle of a DL-TB in the case of a shortened TTI. For example, the TTI may be a 2-OFDM-symbol-long TTI. When data transmission occurs in a higher layer at the eNB 1160 side, the eNB 1160 may determine physical layer parameters for an initial transmission of the DL-TB. The eNB 1160 may transmit 1101 SPDCCH 1083 carrying DL assignment and the corresponding SPDSCH 1085 carrying the DL-TB(s) in the same TTI.

If the UE 1102 detects SPDCCH 1083 carrying the DL assignment, the UE 1102 may attempt to decode DL-TB in the corresponding SPDSCH 1085. If the UE 1102 succeeds to decode DL-TB, then the UE 1102 may report 1103 ACK as the HARQ-ACK in the TTI that is 4-TTI later than the TTI carrying the DL assignment and DL-TB. Otherwise, the UE 1102 may report 1103 NACK as the HARQ-ACK in that TTI.

When the eNB 1160 receives NACK, the eNB 1160 may re-transmit 1105 the DL-TB in the TTI that is 4-TTI later than the TTI carrying HARQ-ACK. Similarly, the next retransmission may be performed in the 8-TTI later TTI than the TTI of the 1st retransmission.

Eventually, the retransmission cycle is 8 TTIs, which is equal to 16 OFDM symbols for the 2-OFDM-symbol-long TTI. In other words, a given DL-TB may be transmitted in every 16 OFDM symbol at minimum as long as the UE 1102 reports NACK for the DL-TB. The latency in the physical layer becomes much shorter than the normal TTI.

FIG. 12 illustrates an example of a retransmission cycle of a UL-TB in the case of a shortened TTI. For example, the TTI may be a 2-OFDM-symbol-long TTI. This example is based on a contention-based UL transmission. When data transmission occurs in a higher layer at the UE side, the UE 1202 may determine physical layer parameters for an initial transmission of the UL-TB. The UE 1202 may transmit 1201 SPUCCH 1087 carrying a UL assignment and the corresponding SPUSCH 1089 carrying the UL-TB(s) in the same TTI.

If the eNB 1260 detects SPUCCH 1087 carrying the UL assignment, the eNB 1260 may attempt to decode UL-TB in the corresponding SPUSCH 1089. If the eNB 1260 succeeds in decoding the UL-TB, then the eNB 1260 may report 1203 ACK as the HARQ-ACK in the TTI that is 4-TTI later than the TTI carrying the UL assignment and UL-TB. Otherwise, the eNB 1260 may report 1203 NACK as the HARQ-ACK in that TTI.

When the UE 1202 receives NACK, the UE 1202 may re-transmit 1205 the UL-TB in the TTI that is 4-TTI or more later than the TTI carrying HARQ-ACK. Similarly, the next retransmission may be performed in the 8-TTI later TTI than the TTI of the 1st retransmission.

Eventually, the minimum retransmission cycle is 8 TTIs, which is equal to 16 OFDM symbols for the 2-OFDM-symbol-long TTI. In other words, a given UL-TB may be transmitted in every 16 OFDM symbol at minimum as long as the eNB 1260 reports NACK for the UL-TB. The latency in the physical layer becomes much shorter than the normal TTI.

FIG. 13 illustrates another example of a retransmission cycle of a UL-TB in the case of a shortened TTI. For example, the TTI may be a 2-OFDM-symbol-long TTI. This example is based on a UL semi-persistent scheduling (SPS)-based UL transmission. The eNB 1360 may first configure 1301 SPS resources for the UE 1302 using a dedicated RRC message and then the eNB 1360 activates 1303 SPS.

Once the SPS for the UE 1302 is activated, periodic resources are reserved for the UE 1302 (or a UE group including the UE 1302). As long as the UE 1302 does not have any data to transmit, the UE 1302 does not use the periodic resources.

When a transmission of data occurs in a higher layer at the UE side, the UE 1302 may perform an initial transmission of the UL-TB though one of the periodic resources (e.g., the immediately coming resource after the data occasion). A higher layer of the UE 1302 may deliver 1305 the UL-TB. The UE 1302 may transmit 1307 SPUSCH 1089 carrying the UL-TB(s) in the TTI including that resource. Alternatively, the UE 1302 may transmit SPUCCH 1087 carrying UL assignment, which indicates PUSCH 779 parameter (e.g., MCS, HARQ process number, redundancy version, etc.), and the corresponding SPUSCH 1089 carrying the UL-TB(s) in that TTI.

Once the eNB 1360 has activated SPS, the eNB 1360 may keep monitoring the corresponding periodic resources. In other words, the eNB 1360 may attempt to detect UL-TB in the SPUSCH 1089 in every activated SPS resource. If the eNB 1360 succeeds to decode UL-TB, then the eNB 1360 may report 1309 ACK as the HARQ-ACK in the TTI that is 4-TTI later than the TTI carrying the UL assignment and UL-TB. Otherwise, the eNB 1360 may report 1309 NACK as the HARQ-ACK in that TTI.

When the UE 1302 receives NACK, the UE 1302 may re-transmit 1311 the UL-TB in the TTI that is 4-TTI or more later than the TTI carrying HARQ-ACK. Alternatively, the eNB 1360 may send 1309 only ACK via SPDCCH 1083 but may never send NACK for the UL SPS-based SPUSCH 1089. In this case, the UE 1302 may automatically re-transmit the UL-TB(s) in that TTI. Similarly, the next retransmission may be performed in the 8-TTI later TTI than the TTI of the 1st retransmission.

Eventually, the minimum retransmission cycle is 8 TTIs, which is equal to 16 OFDM symbols for the 2-OFDM-symbol-long TTI. In other words, a given UL-TB may be transmitted in every 16 OFDM symbol at minimum as long as the eNB 1360 reports NACK for the UL-TB. The latency in the physical layer becomes much shorter than the normal TTI.

If the eNB 1360 thinks that all possible UL transmissions have been done, the eNB 1360 may release 1313 SPS. After that, the UE 1302 may not be allowed to use the configured SPS resources and the eNB 1360 may not have to monitor those resources any more.

FIG. 14 illustrates examples of RE mapping of SPDCCH 1483 and SPDSCH 1485. For a SPDCCH 1483 transmission, only discrete subcarriers (e.g., every×subcarrier) may be used.

In Example (a), the SPDCCH 1483 is mapped to REs 1489 that correspond to the subcarriers that are located with a uniform interval in the frequency domain. More specifically, the SPDCCH 1483 is mapped to REs 1489 whose frequency indices k fulfills the condition that mod(k, x)=a. Although a is assumed to be 0 in the shown example, another value may also be available. On the other hand, all subcarriers within the system band may be available for SPDSCH 1485 transmission.

One or more SPDCCH 1483 may be mapped on these REs 1489. As in PDCCH 771 monitoring, blind decoding may be assumed for SPDCCH 1483 transmission/reception. To be more specific, CRC bits of which sequence corresponds to an intended UE's RNTI may be attached to SPDCCH 1483. The UE 102 may attempt to decode, then the UE 102 may recognize that SPDCCH 1483 is intended for that UE 102 if CRC bits are matched to its RNTI.

Alternately, unlike the PDCCH 771, blind decoding might not be assumed for the SPDCCH 1483 transmission/reception. In this case, CRC bits with a common sequence may be attached to SPDCCH 1483.

The DCI format carried by the SPDCCH 1483 may include a bit field for indicating an intended UE (e.g., RNTI). In this case, one SPDCCH 1483, which is mapped to REs 1489 within a whole system band, as shown in Example (a), may be transmitted in a TTI. Alternatively, one SPDCCH 1483 (and also the corresponding SPDSCH 1485) may be mapped to REs within a part of the system band, as shown in Example (b). Which part of the system band that is used may depend on a cell specific parameter (e.g., physical cell identity) so that inter-cell interference can be mitigated.

The SPDCCH 1483 may also carry HARQ-ACK for a UL transmission. If frequency multiplexing is not applied in SPDSCH 1485 transmissions, the DCI format may not have the bit field indicating physical resource block assignment for SPDSCH 1485. It should be noted that reference signal for demodulation of SPDCCH 1483/SPDSCH 1485 may be inserted and may be mapped on a part of the above-described available REs for the SPDCCH 1483/SPDSCH 1485 transmissions.

In these examples, SPDCCH 1483 may occupy one OFDM symbol and SPDSCH 1485 may occupy another OFDM symbol. In another alternative, the REs in the SPDCCH 1483 symbol may also be used to carry SPDSCH 1485. The RE 1489 resources may be divided into several groups and indicated by the DCI in the SPDCCH 1483. In this implementation, PDCCH 771 only use the first symbol, PDSCH 773 can use the remaining REs 1489 in the first symbol.

In another implementation, the SPDCCH 1483 may spread into 2 OFDM symbols following a defined pattern. The pattern may have different aggregation levels. Similarly, the SPDSCH 1485 resource is also defined by patterns. The resources used for PDSCH 773 transmission are indicated by DCI carried on the SPDCCH 1483. In this implementation, PDCCH 771 and PDSCH 773 use both symbols.

FIG. 15 illustrates an example of a time domain signal of SPDCCH 1083. When SPDCCH 1083 is mapped only on every x subcarrier, x-time-repeated patterns appear on sample points within its effective OFDM symbol 1595 duration (excluding the cyclic prefix 1593).

From the receiver point of view, it is possible to extract the SPDCCH 1083 information by using only one set of the pattern (e.g., the first set of samples 1597 that corresponds to the first one of x-time repetitions 1599) if it achieves a sufficient SNR. This may bring the benefit that the receiver is able to start decoding earlier than the end of the OFDM symbol 1591.

Eventually, the limitation on the UE's 102 processing time for decoding of SPDCCH 1083 may be alleviated and the UE 102 may be able to start SPDSCH 1085 decoding immediately after the TTI ends.

FIG. 16 illustrates examples of RE 1689 mapping of SPUCCH 1687 and SPUSCH 1689. For both SPUCCH 1687 and SPUSCH 1689 transmissions, only discrete subcarriers (e.g., every x subcarrier) may be used. The SPUCCH 1687 may also carry HARQ-ACK for a DL transmission.

This SPUCCH 1687 structure may bring the similar benefits as SPDCCH 1083 as described above. For contention-based UL transmission, the frequency location of SPUCCH 1687 and SPUSCH 1689 may be determined by the UE 102. For the contention-based SPUSCH 1689 transmission, the UE 102 may be configured with one or more SPUSCH 1689 resource pools by the eNB 160.

Each SPUSCH 1689 resource pool may consist of one or more SPUSCH 1689 resources. The UE 102 may select one SPUSCH 1689 resource from the configured resource pool when a UL data transmission occurs. Each SPUSCH 1689 may be identified by its frequency position. In other words, its frequency position may be derived using its SPUSCH 1689 index.

In an approach the first resource pool may include SPUSCH 1689 resources shown in Examples (a) and (b). The second resource pool may include SPUSCH 1689 resources shown in Examples (c) and (d).

In the implementation depicted in these examples, SPUCCH 1687 occupies one OFDM symbol and SPUSCH 1689 occupies another OFDM symbol. In another alternative, the REs 1689 1689 in the SPUCCH 1687 symbol may also be used to carry SPUSCH 1689. Within a symbol, the RE 1689 resources for SPUSCH 1689 may be separated from the RE 1689 region for SPUCCH 1687, or SPUSCH 1689 will puncture REs 1689 of SPUSCH 1689 in the same symbol if both of them are transmitted. In this implementation, PUCCH 777 only uses the first symbol, PUSCH 779 can use the remaining REs 1689 in the first symbol (by puncturing or rate matching, for example).

In another implementation, the SPUCCH 1687 may spread into 2 OFDM symbols following a defined pattern. Similarly, the SPDSCH 1085 resource is also spread into 2 symbols with defined patterns. Again, the RE 1689 resources for SPUSCH 1689 may be separated from the RE 1689 region for SPUCCH 1687, or SPUSCH 1689 will puncture REs 1689 of SPUSCH 1689 in the same symbol if both of them are transmitted. In this implementation, PUCCH and PUSCH 779 use both symbols, PUCCH resource may be reserved or punctured from PUSCH 779 (similar to multiplexing, for example).

FIG. 17 illustrates an example of a retransmission cycle of a DL-TB with a shortened RTT. When data transmission occurs in a higher layer at the eNB side, the eNB 1760 may determine physical layer parameters for an initial transmission of the DL-TB. The eNB 1760 may transmit 1701 a DL assignment and the corresponding PDSCH 773 carrying the DL-TB(s) in the same subframe.

If the UE 1702 detects PDCCH 771/EPDCCH 775 carrying the DL assignment, the UE 1702 may attempt to decode DL-TB in the corresponding PDSCH 773. If the UE 1702 succeeds to decode DL-TB, then the UE 1702 may report 1703 ACK as the HARQ-ACK in the subframe 2-TTI later than the subframe carrying the DL assignment and DL-TB. Otherwise, the UE 1702 may report 1703 NACK as the HARQ-ACK in that subframe.

When the eNB 1760 receives NACK, the eNB 1760 may re-transmit 1705 the DL-TB in the subframe 2-TTI later than the subframe carrying HARQ-ACK. Similarly, the next retransmission may be performed in the subframe 4-TTI later than the subframe of the 1st retransmission.

Eventually, the retransmission cycle is 4 TTIs. In other words, a given DL-TB may be transmitted in every 4 subframe at minimum as long as the UE 1702 reports NACK for the DL-TB.

FIG. 18 illustrates an example of a retransmission cycle of a UL-TB with the shortened RTT. When data transmission occurs in a higher layer at the UE side, the UE 1802 may send 1801 a scheduling request (SR) or may initiate a RACH procedure instead of sending SR.

If the eNB 1860 receives the SR or finished the RACH procedure, the eNB 1860 may determine physical layer parameters (e.g., MCS, PRB assignment, etc.) for an initial transmission of the UL-TB. The eNB 1860 may transmit 1803 a UL grant. If the UE 1802 detects a PDCCH 771/EPDCCH 775 carrying the UL grant, the UE 1802 may transmit 1805 PUSCH 779 containing the UL-TB in the subframe 2-TTI later than the subframe carrying the UL grant. The eNB 1860 may attempt to decode the UL-TB.

If the UE 1802 succeeds to decode DL-TB, then the eNB 1860 may report 1807 ACK as the HARQ-ACK or may send 1807 another UL grant scheduling a new UL-TB in the subframe 2-TTI later than the subframe carrying the UL-TB. Otherwise, the eNB 1860 may report 1807 NACK as the HARQ-ACK or may send 1807 another UL grant scheduling the same UL-TB in that subframe.

When the UE 1802 receives NACK or another UL grant scheduling the same UL-TB, the UE 1802 may re-transmit 1809 the UL-TB in the subframe 2-TTI later than the subframe carrying the HARQ-ACK or the UL grant. Similarly, the next retransmission may be performed in the subframe 4-TTI later than the subframe of the 1st retransmission.

Eventually, the retransmission cycle is 4 TTIs. In other words, a given UL-TB may be transmitted in every 4 subframe at minimum as long as the eNB 1860 reports NACK or sends a UL grant initiating a retransmission for the UL-TB.

The shortened 2-TTI interval provides a RTT of 4 TTIs, with a 2 OFDM symbol TTI, the RTT is 8 symbols. If the interval is 3 TTIs, the RTT is 6 TTIs, with a 2 OFDM symbol TTI, the RTT is 12 symbols. Both of them are under 1 ms RTT.

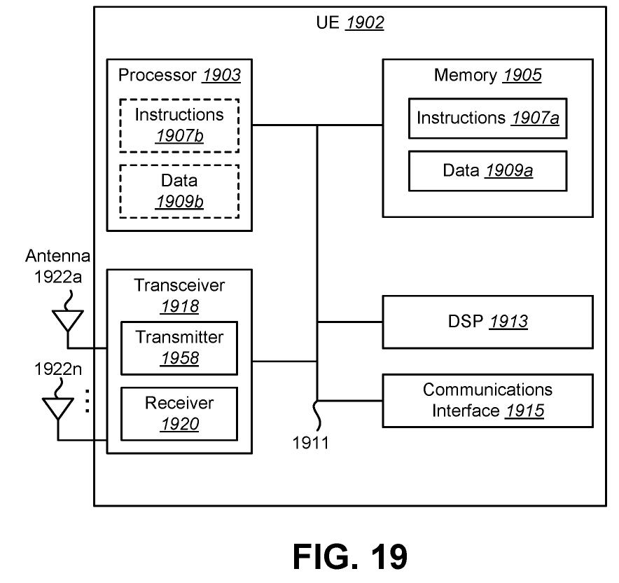

FIG. 19 illustrates various components that may be utilized in a UE 1902. The UE 1902 described in connection with FIG. 19 may be implemented in accordance with the UE 102 described in connection with FIG. 1. The UE 1902 includes a processor 1903 that controls operation of the UE 1902. The processor 1903 may also be referred to as a central processing unit (CPU). Memory 1905, which may include read-only memory (ROM), random access memory (RAM), a combination of the two or any type of device that may store information, provides instructions 1907a and data 1909a to the processor 1903. A portion of the memory 1905 may also include non-volatile random access memory (NVRAM). Instructions 1907b and data 1909b may also reside in the processor 1903. Instructions 1907b and/or data 1909b loaded into the processor 1903 may also include instructions 1907a and/or data 1909a from memory 1905 that were loaded for execution or processing by the processor 1903. The instructions 1907b may be executed by the processor 1903 to implement the method 300 described above.

The UE 1902 may also include a housing that contains one or more transmitters 1958 and one or more receivers 1920 to allow transmission and reception of data. The transmitter(s) 1958 and receiver(s) 1920 may be combined into one or more transceivers 1918. One or more antennas 1922a-n are attached to the housing and electrically coupled to the transceiver 1918.

The various components of the UE 1902 are coupled together by a bus system 1911, which may include a power bus, a control signal bus and a status signal bus, in addition to a data bus. However, for the sake of clarity, the various buses are illustrated in FIG. 19 as the bus system 1911. The UE 1902 may also include a digital signal processor (DSP) 1913 for use in processing signals. The UE 1902 may also include a communications interface 1915 that provides user access to the functions of the UE 1902. The UE 1902 illustrated in FIG. 19 is a functional block diagram rather than a listing of specific components.

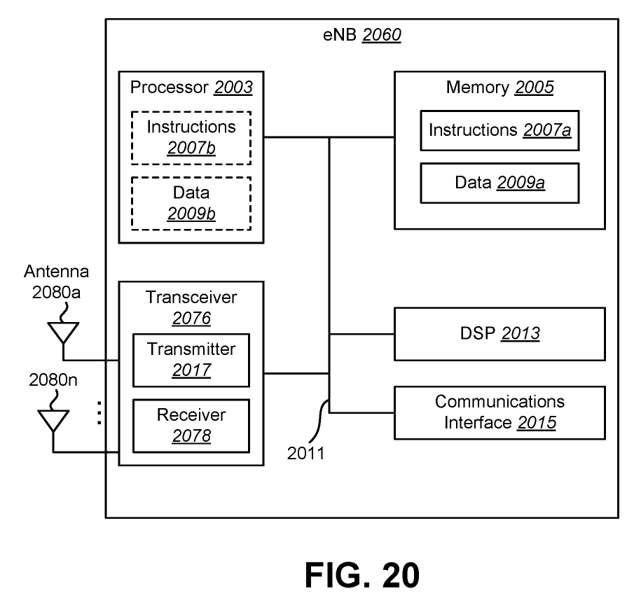

FIG. 20 illustrates various components that may be utilized in an eNB 2060. The eNB 2060 described in connection with FIG. 20 may be implemented in accordance with the eNB 160 described in connection with FIG. 1. The eNB 2060 includes a processor 2003 that controls operation of the eNB 2060. The processor 2003 may also be referred to as a central processing unit (CPU). Memory 2005, which may include read-only memory (ROM), random access memory (RAM), a combination of the two or any type of device that may store information, provides instructions 2007a and data 2009a to the processor 2003. A portion of the memory 2005 may also include non-volatile random access memory (NVRAM). Instructions 2007b and data 2009b may also reside in the processor 2003. Instructions 2007b and/or data 2009b loaded into the processor 2003 may also include instructions 2007a and/or data 2009a from memory 2005 that were loaded for execution or processing by the processor 2003. The instructions 2007b may be executed by the processor 2003 to implement the method 400 described above.

The eNB 2060 may also include a housing that contains one or more transmitters 2017 and one or more receivers 2078 to allow transmission and reception of data. The transmitter(s) 2017 and receiver(s) 2078 may be combined into one or more transceivers 2076. One or more antennas 2080a-n are attached to the housing and electrically coupled to the transceiver 2076.

The various components of the eNB 2060 are coupled together by a bus system 2011, which may include a power bus, a control signal bus and a status signal bus, in addition to a data bus. However, for the sake of clarity, the various buses are illustrated in FIG. 20 as the bus system 2011. The eNB 2060 may also include a digital signal processor (DSP) 2013 for use in processing signals. The eNB 2060 may also include a communications interface 2015 that provides user access to the functions of the eNB 2060. The eNB 2060 illustrated in FIG. 20 is a functional block diagram rather than a listing of specific components.

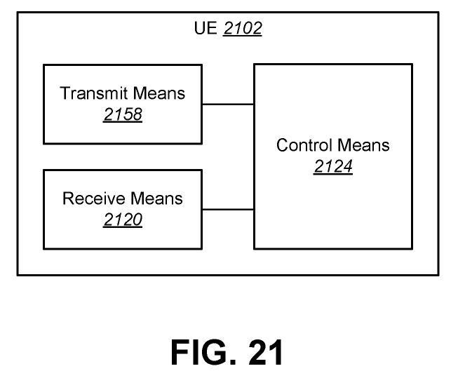

FIG. 21 is a block diagram illustrating one implementation of a UE 2202 in which systems and methods for performing low latency radio communications may be implemented. The UE 2202 includes transmit means 2258, receive means 2220 and control means 2224. The transmit means 2258, receive means 2220 and control means 2224 may be configured to perform one or more of the functions described in connection with FIG. 1 above. FIG. 19 above illustrates one example of a concrete apparatus structure of FIG. 21. Other various structures may be implemented to realize one or more of the functions of FIG. 1. For example, a DSP may be realized by software.

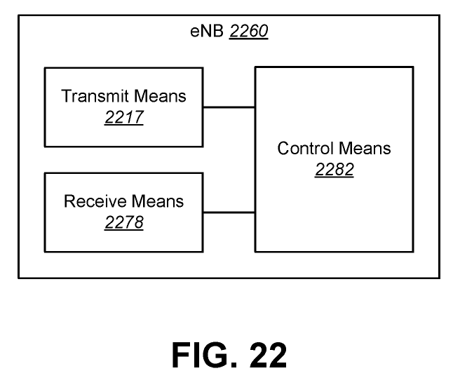

FIG. 22 is a block diagram illustrating one implementation of an eNB 2360 in which systems and methods for performing low latency radio communications may be implemented. The eNB 2360 includes transmit means 2317, receive means 2378 and control means 2382. The transmit means 2317, receive means 2378 and control means 2382 may be configured to perform one or more of the functions described in connection with FIG. 1 above. FIG. 20 above illustrates one example of a concrete apparatus structure of FIG. 22. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the eNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the eNB 160 and the UE 102 according to the systems and methods described above may be realized as an LSI that is a typical integrated circuit. Each functional block of the eNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A user equipment (UE) comprising:
a higher-layer processor configured to configure a secondary cell group (SCG) and to configure a shortened transmission timing interval (TTI) for the SCG; and
a physical channel receiver configured to use a normal TTI for a master cell group (MCG) and to use the shortened TTI for the SCG.

2. The UE of claim 1, wherein:
the shortened TTI consists of two orthogonal frequency division multiplexing (OFDM) symbols, a first OFDM symbol of the two OFDM symbols contains a physical control channel, and a second OFDM symbol of the two OFDM symbols contains a physical shared channel.

3. The UE of claim 2, wherein:
the physical control channel is mapped on discrete subcarriers of which frequency intervals are uniform.

4. An evolved node B (eNB) comprising:
a higher-layer processor configured to configure, in a user equipment (UE), a secondary cell group (SCG) and to configure a shortened transmission timing interval (TTI) for the SCG,
a physical channel transmitter configured to use a normal TTI for a master cell group (MCG) and to use the shortened TTI for the SCG;

5. The eNB of claim 4, wherein:
the shortened TTI consists of two orthogonal frequency division multiplexing (OFDM) symbols, a first OFDM symbol of the two OFDM symbols contains a physical control channel, and a second OFDM symbol of the two OFDM symbols contains a physical shared channel.

6. The eNB of claim 5, wherein:
the physical control channel is mapped on discrete subcarriers of which frequency intervals are uniform.

7. A method in a user equipment (UE) comprising:
configuring a secondary cell group (SCG);
configuring a shortened transmission timing interval (TTI) for the SCG;
using a normal TTI for a master cell group (MCG); and
using the shortened TTI for the SCG.

8. A method in an evolved node B (eNB) comprising:
configuring, in a user equipment (UE), a secondary cell group (SCG);
configuring a shortened transmission timing interval (TTI) for the SCG;
using a normal TTI for a master cell group (MCG); and
using the shortened TTI for the SCG.

9. A method for a user equipment (UE), the method comprising:
configuring a secondary cell group (SCG);
configuring a shortened transmission timing interval (TTI) for the SCG;
using a normal TTI for a master cell group (MCG); and
using the shortened TTI for the SCG.

10. A method for an evolved node B (eNB), the method comprising:
configuring, in a user equipment (UE), a secondary cell group (SCG);
configuring, in the user equipment (UE), a shortened transmission timing interval (TTI) for the SCG;
using a normal TTI for a master cell group (MCG); and
using the shortened TTI for the SCG.
